(19) United States
(12) Patent Application Publication
(10) Pub. No.: US 2014/0032187 A1
(43) Pub. Date: Jan. 30, 2014

(54) STOCHASTIC STATE ESTIMATION FOR SMART GRIDS

(71) Applicants: Motto Alexis Legbedji, Princeton, NJ (US); Andrey Torzhkov, Lafayette, CA (US); Amit Chakraborty, East Windsor, NJ (US)

(72) Inventors: Motto Alexis Legbedji, Princeton, NJ (US); Andrey Torzhkov, Lafayette, CA (US); Amit Chakraborty, East Windsor, NJ (US)

(73) Assignee: SIEMENS CORPORATION, Iselin, NJ (US)

(21) Appl. No.: 13/880,449

(22) PCT Filed: Nov. 4, 2011
(86) PCT No.: PCT/US11/59270

§ 371 Date: Oct. 17, 2013

Related U.S. Application Data
(60) Provisional application No. 61/410,084, filed on Nov. 4, 2010.

(51) Int. Cl. G06F 17/50

(52) U.S. Cl. CPC G06F 17/5009
USPC 703/2

(57) ABSTRACT

A method of approximating a solution of a stochastic state estimation (SSE) model of an electric grid, includes choosing (70) starting anchor points in an SSE model of an electric grid, relaxing (71) constraints of an SSE objective function to solve for a feasible solution of the SSE model, calculating (72) updated dual variables and infeasibility reduction directions from the feasible solution, generating (73) a linear cut for the chosen starting anchor points, choosing (74) a step size toward the reduction directions, and updating (75) the anchor points through branching by making the chosen step, wherein each anchor point defines a rectangle that at least partially covers a feasible solution set of the SSE model and the set of rectangles covering the feasible solution set of the SSE model define an approximate solution of the SSE model of said electric grid.

### CROSS REFERENCE TO RELATED UNITED STATES APPLICATIONS

This application claims priority from “Stochastic State Estimation For Smart Grids Using Interior Point Method”, U.S. Provisional Application No. 61/410,084 of Motto, et al., filed Nov. 4, 2010, the contents of which are herein incorporated by reference in their entirety.

### TECHNICAL FIELD

This disclosure is directed to methods for stochastic distribution system state estimation for smart grids.

### DISCUSSION OF THE RELATED ART

Distribution system state estimation produces a real-time estimate of a distribution network model by extracting information from a redundant input data set consisting of remote sensor, predicted and static data items. Consider the state estimation task, where x denotes an n-dimensional state vector, z denotes an m-dimensional observation vector, u denotes a vector of observation noise, assumed independent and driven by Gaussian probability law, and h denotes a vector function relating state and observation variables:

z₁−h₁(x)=ν, (1a)

z₂−h₂(x)=0, (1b)

h₁≦h₁≦ h̅₁̅ (1c)

The constraints of EQ. (1a) state that a sub-vector of the measurement residual, z₁−h₁(x), is a random variable. The constraints of EQ. (1b) state that a sub-vector of the measurement residual, z₂−h₂(x), is known deterministically. The constraints of EQ. (1c) state that a subvector of the measurement function, h₁, is box-constrained.

In a power system state estimation task formulation, x denotes power system state variables, e.g. node voltage magnitudes and angles, transformer voltage magnitude and angle tap positions, node active and reactive power injections. The function h expresses the electrical relationships between the state variables and the measurements. Constraints (1a) could model voltage magnitude and/or angle measurements with imperfect sensors. Constraints (1b) could model zero-injection active and reactive power pseudo-measurements. Constraints (1c) could model physical and operational requirements that the network state should not be viable unless transformer tap positions, branch current magnitude, active and reactive power flows, node voltage magnitudes and angles are within some associated box constraints. In addition, standard operation practice and physical laws require that some power system variables lie within three regions, defined by three limit pairs, namely, operational limits (OPL), long-term emergency limits (LTEL), and short-term emergency limits (SHTEL). In addition, most variables may not lie outside an interval defined by a pair of reasonability or viability limits (VIAL). For example, the voltage magnitude at some node is normally constrained as follows:

Vᵢ⁴≦Vᵢ³≦Vᵢ²≦Vᵢ¹≦Vᵢ≦ V̅ᵢ̅¹̅≦ V̅ᵢ̅²̅≦ V̅ᵢ̅³̅≦ V̅ᵢ̅⁴̅, (2)

where [Vᵢ¹, V̅ᵢ¹], [Vᵢ², V̅ᵢ²], [Vᵢ³, V̅ᵢ³], [Vᵢ³, V̅ᵢ³] denote operational box, long-term emergency box, short-term emergency box, and reasonability box, respectively.

The power system state estimation task is then cast as a constrained mathematical optimization problem:

minJ(x) (3)

s.t.z₂−h₂(x)=0 (4)

h≦h≦ h̅ (5)

where the following objective function is used in the least square framework:

J(x)=[z−h(x)]^{T}W[z−h(x)]. (6)

Unconstrained weighted least squares (WLS) approaches omit the constraints in EQ. (5) or handle them in a non-systematic way. Constrained WLS approaches incorporate either a subset of or all constraints. An issue with unconstrained WLS approach lies in its requirement of associating a large weight to each component of the measurement residual z₂−h₂(x). The unconstrained WLS framework is inadequate for dealing with box constraints. The constrained WLS is more suitable for handling the constraints. However, existing constrained WLS approaches are based on general nonlinear solution techniques or linear approximation that are not scalable to large-scale power system network models, with three-phase unbalanced distribution network being a conspicuous example.

As distribution system utilities are facing more regulatory and customer pressures to improve power supply reliability, to reduce losses and to address power quality issues arising from an ever-growing penetration of grid-connected dispersed generation, there is a need for state estimation software that is fast and highly scalable. A distribution management system (DMS) or control center, endowed with efficient monitoring applications, will improve the performance of distribution networks operation and control. New control capabilities, for loads as well as distributed generators, will enhance the controllability of a distribution network. Such level of controllability would, however, remain in the conceptual realm unless distribution control systems and control engineers are fed with estimates of network states that are more accurate than are currently available.

### SUMMARY

Exemplary embodiments of the invention as described herein generally include methods and systems for a new state estimation approach for distribution networks, which have intrinsically lower measurement redundancy than in transmission networks. A new state estimation model according to an embodiment of the invention takes account of network phase unbalance, switching devices and discrete controls such as switchable shunt capacitors and reactors, transformers magnitude and phase tap positions, as well as renewable generators. A stochastic state estimation (SSE)-model-specific interior-point and cutting-plane method according to an embodiment of the invention has been demonstrated to be applicable to the stochastic state estimation of multi-phase unbalanced power systems. A state estimator according to an embodiment of the invention is general, highly scalable and applies to transmission as well as distribution network systems. A state estimation framework according to an embodiment of the invention takes account of distribution systems with renewable generators, as well as jumps, induced by network switching events.

According to an aspect of the invention, there is provided a method for approximating a solution of a stochastic state estimation (SSE) model of an electric grid, including (1) choosing starting anchor points in an SSE model of an electric grid, (2) relaxing constraints of an SSE objective function to solve for a feasible solution of the SSE model, (3) calculating updated dual variables and infeasibility reduction directions from the feasible solution, (4) generating a linear cut for the chosen starting anchor points, (5) choosing a step size toward the reduction directions; and (6) updating the anchor points through branching by making the chosen step, wherein each anchor point defines a rectangle that at least partially covers a feasible solution set of the SSE model, wherein each rectangle is a convex set, and the set of rectangles covers the feasible solution set of the SSE model.

According to a further aspect of the invention, the method includes (7) repeating steps (2) through (6) until either a feasible solution is found or an infeasibility check is true.

According to a further aspect of the invention, the method includes (8) pre-solving a few-iterations of a primal of a convexified SSE model.

According to a further aspect of the invention, the method includes (9) calculating updated primal variables and reduced cost directions.

According to a further aspect of the invention, the method includes (10) repeating steps (4) through (9) until either an optimal solution is found or an iteration limit is reached.

According to another aspect of the invention, there is provided a method for finding an optimal solution of a stochastic state estimation (SSE) model of an electric grid, including (1) providing a convexified SSE model of an electric grid, said convexified SSE model including an objective function having an objective value, a plurality of constraints, and a convex hull, (2) initializing a node list with a solution of the SSE objective function in its convex hull, an optimal solution of the SSE model to an empty set, and upper and lower bounds of the objective value of the objective function, (3) selecting a node from the node list and initializing a first cutting plane to a constraint associated with said node, (4) solving the objective function subject for the first cutting plane to obtain a current solution and saving the objective value of the current solution of the objective function, (5) updating the objective value upper bound to a largest optimal objective value among current nodes, (6) if the current solution of the SSE model is a feasible solution of the SSE model, and if the objective value of the current solution is greater than the objective value lower bound, setting the objective value lower bound to the current solution objective value and the optimal solution of the SSE model to the current solution of the SSE model, (7) if a number of cutting plane is less than a predetermined maximum and if the objective value of the current solution is greater than the objective value lower bound, generate a plurality of new cutting planes for the current node to produce a tighter feasible region of the SSE model, and (8) if the number of cutting plane is greater than the predetermined maximum, create two new nodes and a constraint for each new mode, and add the new nodes to the node list.

According to a further aspect of the invention, the method includes, if the node list is empty, setting the optimal solution of the SSE model to the current solution of the SSE model, and the optimal objective value of the SSE model to the current solution objective value.

According to a further aspect of the invention, the method includes, if the current solution of the SSE model is infeasible, repeating steps (3) and (4).

According to a further aspect of the invention, the method includes, if the objective value of the current solution is less than the objective value lower bound, repeating steps (3) through (5).

According to another aspect of the invention, there is provided a non-transitory program storage device readable by a computer, tangibly embodying a program of instructions executed by the computer to perform the method steps for covering a feasible region of a stochastic state estimation (SSE) model of an electric grid.

According to another aspect of the invention, there is provided a non-transitory program storage device readable by a computer, tangibly embodying a program of instructions executed by the computer to perform the method steps for finding an optimal solution of a stochastic state estimation (SSE) model of an electric grid.

### BRIEF DESCRIPTION OF THE DRAWINGS

FIG. 1 depicts Tables 1 and 2, which summarize the states variables, measurements and pseudo-measurements used in an SE, according to an embodiment of the invention.

FIG. 2 depicts a one-phase power system, according to an embodiment of the invention.

FIG. 3 depicts a reduced network model post-NTP, according to an embodiment of the invention.

FIG. 4 depicts a network unified compound π diagram, according to an embodiment of the invention.

FIG. 5 illustrates the forms of the feasibility sets of Fᵢⱼ^{S} and Fᵢⱼ^{C} on the complex plane, according to an embodiment of the invention.

FIG. 6 illustrates the idea of rectangle coverage accuracy, according to an embodiment of the invention

FIG. 7 is a flow chart of an algorithm for covering a feasible region, according to an embodiment of the invention.

FIG. 8 shows a branch-and-bound tree for EQS. (91), according to an embodiment of the invention.

FIG. 9 is a flowchart of a branch-and-cut algorithm according to an embodiment of the invention.

FIG. 10 is a block diagram of an exemplary computer system for implementing an SSE-model-specific interior-point and cutting-plane method for state estimation in a distribution network, according to an embodiment of the invention.

### DETAILED DESCRIPTION OF EXEMPLARY EMBODIMENTS

Exemplary embodiments of the invention as described herein generally include systems and methods for state estimation in a distribution network. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

### Nomenclature

The main notation used throughout the present disclosure is summarized below.

### Acronyms

AC Alternating Current

AMI Advanced Metering Infrastructure.

DER Distributed Energy Resource.

DMS Distribution Management System.

DSE Distribution System Sate Estimation.

MIP Mixed-Integer Programming.

MIQP Mixed Integer Quadratic Program.

NLP Nonlinear Programming.

NTP Network Topology Processing or Network Topology Processor.

PV Photovoltaic.

QP Quadratic Programming.

SCADA Supervisory Control and Data Acquisition System.

SLP Successive Linear Programming

WLS Weighted Least Squares.

### Variables

Iᵢⱼ Current flow magnitude at origin terminal of branch ij.

Iⱼᵢ Current flow magnitude at sending terminal of branch ij.

Pᵢⱼ Active power flow at origin terminal of branch ij.

Pⱼᵢ Active power flow at destination terminal of branch

Qᵢⱼ Reactive power flow at origin terminal of branch ij.

Qⱼᵢ Reactive power flow at destination terminal of branch

Vₖ Voltage magnitude at node or bus k.

θₖ Voltage angle at node or bus k.

sᵢⱼ Status of switch ij.

### Other Mathematical Symbols

∇ₓh gradient of the function h with respect to x.

∇ₓ²h Hessian of the function h with respect to x.

x^{T} transpose of x.

Additional symbols used here are dual variables, which are mnemonically displayed on top of the corresponding equality or inequality symbols. If x is a variable, then x and x̅ denote the lower limit and upper limit, respectively, of x. Other symbols with a narrower scope are defined in the subsections where they are used.

### 1 Introduction

A new state estimation solver according to an embodiment of the invention can address the following requirements:

Full library of power models suitable for smart grids;

Multi-phase unbalanced power distribution systems;

Real-time (1-5s) estimation;

Distributed operation;

Non-systematic/inadequate sensor observability;

Switching events;

High penetration of intermittent local generation; and

Variety mix of known and unknown Volt/Var control modes.

An SSE algorithm according to an embodiment of the invention has the following features, which are applicable to SE:
support various types of power flow constraints;
implement a model-specific primal-dual interior point method, which is fast and scalable, owing to usage of a fully continuous solver, applied to a locally linearized SSE, and matrix partitioning into ‘super-node blocks’;
implement a novel SSE iterative convexification scheme, which leans on a new coarse discretization of non-linear AC voltage law, a novel branch-and-cut (i.e. branch-and-bound with cutting planes) discretization management scheme, and model-specific cutting planes to speed up the global solution search; and
implement a novel parametric relaxation model for network topology, by starting from a previous solution following a network topology change. This is achieved by means of continuous parameter relaxation.

For switching event filtering, a fast statistical jump-diffusion identification procedure according to an embodiment of the invention can be applied to a pocket of network (i.e. a local area of the network) to identify discrete events in real-time. A procedure according to an embodiment of the invention uses regular continuous sensor measurements, builds a local state-space model with a mix of discrete and continuous events, exploits the fact that a discrete event has a step and duration, casts this problem as a small-scale MIQP, uses a polynomial DP heuristic for solving the MIQP in real-time, and implies a high likelihood of correct identification if there is enough measurement redundancy.

For identification of distributed renewable energy plants, the production vector of a DER array can be modeled by a small set of common dynamic factors. The sensitivity factor of each DER in the array is specific due to local conditions. The value of the common factors vector is short-term predictable. The power injection vector of the DER array is modulated by local protection and power electronic controls. The modulation may have multiple modes switching based on a relay control thresholds/band. Each mode produces a performance curve, following power injection for a band-locked energy production. A model according to an embodiment of the invention can be solved by a machine-learning algorithm, such as SVM or matrix completion. The idea is to forecast short term DER power outputs and terminal voltages, using power injection measurements or pseudo-measurements or previous estimates as well as a common factors observations history to reconstruct the unknown control modes and curves and a DER sensitivity matrix.

### 2 Model Formulation

An SE algorithm according to an embodiment of the invention can perform the following:

(1) Filter network discrete events;
(2) Filter distributed energy plants;

### (3) Perform NTP;

(4) Build the SE model;
(5) Determine observable islands;
(6) Solve a constrained WLS for a network state in every observable island;
(7) Perform bad data analysis;
(8) If bad data was filtered out, repeat from step 6; and
(9) Estimate the network state in all (i.e observable and non-observable) islands

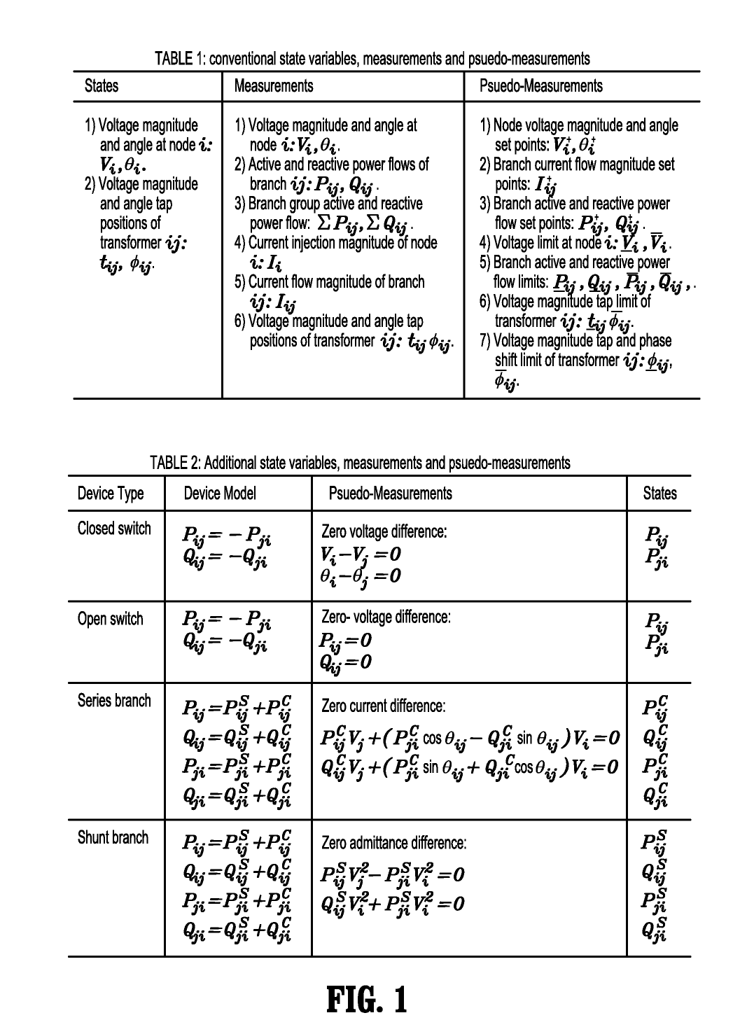

Tables 1 and 2, shown in FIG. 1, summarize the states variables, measurements and pseudo-measurements used in an SE according to an embodiment of the invention.

Since the aforementioned principles are applicable for single-phase or multi-phase systems, some of the main steps of the state estimation approach according to an embodiment of the invention will be highlighted using a single-phase system model.

2.1 Illustration with One-Phase System Model

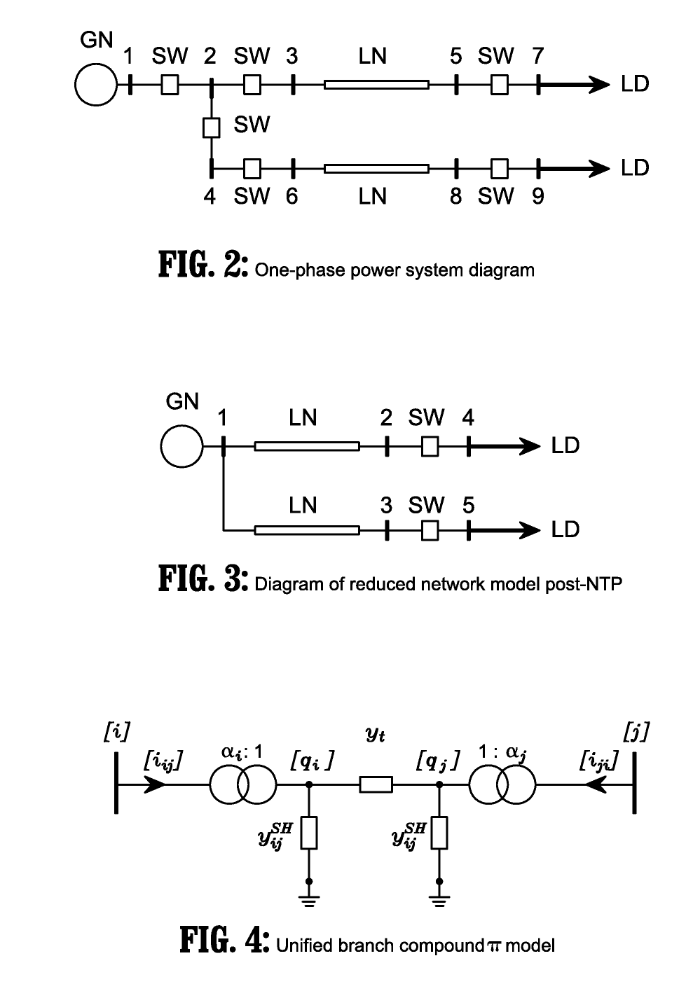

Consider the network of FIG. 2, which is a one-phase power system diagram. The network has nine nodes, numbered from 1 to 9, 5 switches, designated by the symbol SW, one generator, designated by GN, two lines, designated by the symbol LN, and two loads designated by the symbol LD. The lines and switches are further identified by the nodes being connected. Suppose that the following quantities are measured:

Active and reactive power injections at node 1;

Active and reactive power flow at the origin terminal of line 12;

Current flow magnitude at the origin terminal of line 13;

Current flow magnitude at the destination terminal of switch 35;

Voltage magnitudes at nodes 1 and 3;

Voltage angles at nodes 1 and 2;

Status of switch 24; and

Status of switch 35.

In addition, suppose that all switches are closed and that the generator is online.

A basic NTP is carried out, using the available information. Specifically, since all switches are closed, super nodes can be defined by collapsing nodes and switching devices. Note the presence of flow measurements on the switching devices 57 and 89. This scarce data would be lost if switches 57 and 89 were trivially collapsed to form super nodes. In this case, the switches 57 and 89 can be modeled using the generalized SE concept. The generator being online entails that all devices are likely energized.

Note that the switches 57 and 89 can be collapsed after analytically transferring the measurements on switches 57 and 89 to the destination terminals of the line 12 and 13, respectively; for example. However, for the sake of simplicity, this disclosure will omit further exposition on this transformation. 5

The results of the basic NTP yield the reduced network diagram of FIG. 3, after re-numbering and re-ordering of nodes.

The variables of the reduced network model are:

P₁ Active power injection at node 1;

P₂ Active power injection at node 2;

P₂₁ Active power flow at destination terminal of line 12;

P₁₂ Active power flow at origin terminal of line 12;

Q₁ Reactive power injection at node 1;

Q₂ Reactive power injection at node 2;

Q₂₁ Reactive power flow at destination terminal of line 12;

Q₁₂ Reactive power flow at origin terminal of line 12;

Vᵢ Voltage magnitude at node i, i=1, 2, 3, 4, 5;

θᵢ Voltage angle at node i, i=1, 2, 3, 4, 5;

s₂₄ Status of switch 24; and

s₃₅ Status of switch 35.

The model has eighteen state variables. According to an embodiment of the invention, the following variables can be chosen as state variables:

P₁ Active power of injection at node 1;

P₄ Active power injection at node 4;

P₅ Active power injection at node 5;

Q₁ Reactive power injection at node 1;

Q₄ Reactive power injection at node 4;

Q₅ Reactive power injection at node 5;

Vᵢ Voltage magnitude at node i, i=1, 2, 3, 4, 5;

θᵢ Voltage angle at node i, i=1, 2, 3, 4, 5;

s₂₄ Status of switch 24; and

s₃₅ Status of switch 35.

The following notation will now be introduced, where R, G, and B are obtained from transformations of user supplied network admittance parameters:

Rᵢⱼ^{S}=((Gᵢⱼ^{S})²+(Bᵢⱼ^{S})²)^{1/2},∀ij (7)

Rᵢⱼ^{C}=((Gᵢⱼ^{C})²+(Bᵢⱼ^{C})²)^{1/2},∀ij (8)

αᵢⱼ^{S}=arcsin(Bᵢⱼ^{S}/Rᵢⱼ^{S}),∀ij (9)

αᵢⱼ^{C}=arcsin(Bᵢⱼ^{C}/Rᵢⱼ^{C}),∀ij (10)

xᵢ=[P₁,Q₁,I₁,P₂,Q₂,I₂,P₃,Q₃,I₃,P₄,Q₄,I₄,P₅,Q₅,I₅] (11)

xᵢⱼ=[P₁₂,Q₁₂,I₁₂,P₂₁,Q₂₁,I₂₁,P₁₃,Q₁₃,I₁₃,P₃₁,Q₃₁,I₃₁,P₂₄,Q₂₄,I₂₄,P₄₂,Q₄₂,I₄₂,P₃₅,Q₃₅,I₃₅,P₅₃,Q₅₃,I₅₃] (12)

uᵢ=[V₁,θ₁,V₂,θ₂,V₃,θ₃,V₄,θ₄,V₅,θ₅] (13)

uᵢⱼ=[s₂₄,s₃₅] (14)

The network model is defined by the following set of constraints:

$$\begin{matrix} {P}_{12} = {G}_{12}^{S} {V}_{11} + {V}_{12} ( {G}_{12}^{C} cos {θ}_{12} + {B}_{12}^{C} sin {θ}_{12} ) & ( 15 a ) \\ {Q}_{12} = - {B}_{12}^{S} {V}_{11} + {V}_{12} ( {G}_{12}^{C} sin {θ}_{12} - {B}_{12}^{C} cos {θ}_{12} ) & ( 15 b ) \\ {I}_{12}^{2} = {( {R}_{12}^{S} )}^{2} {V}_{11} + {( {R}_{12}^{C} )}^{2} {V}_{22} + 2 {R}_{12}^{S} {R}_{12}^{C} {V}_{12} cos ( {θ}_{12} + {α}_{12}^{S} - {α}_{12}^{C} ) & ( 15 c ) \\ {P}_{21} = {G}_{21}^{S} {V}_{22} + {V}_{21} ( {G}_{21}^{C} cos {θ}_{21} + {B}_{21}^{C} sin {θ}_{21} ) & ( 15 d ) \\ {Q}_{21} = - {B}_{21}^{S} {V}_{22} + {V}_{21} ( {G}_{21}^{C} sin {θ}_{21} - {B}_{21}^{C} cos {θ}_{21} ) & ( 15 e ) \\ {I}_{21}^{2} = {( {R}_{21}^{S} )}^{2} {V}_{22} + {( {R}_{21}^{C} )}^{2} {V}_{11} + 2 {R}_{21}^{S} {R}_{21}^{C} {V}_{21} cos ( {θ}_{21} + {α}_{21}^{S} - {α}_{21}^{C} ) & ( 15 f ) \\ {P}_{13} = {G}_{13}^{S} {V}_{11} + {V}_{13} ( {G}_{13}^{C} cos {θ}_{13} + {B}_{13}^{C} sin {θ}_{13} ) & ( 15 g ) \\ {Q}_{13} = - {B}_{13}^{S} {V}_{11} + {V}_{13} ( {G}_{13}^{C} sin {θ}_{13} - {B}_{13}^{C} cos {θ}_{13} ) & ( 15 h ) \\ {I}_{13}^{2} = {( {R}_{13}^{S} )}^{2} {V}_{11} + {( {R}_{13}^{C} )}^{2} {V}_{33} + 2 {R}_{13}^{S} {R}_{13}^{C} {V}_{13} cos ( {θ}_{13} + {α}_{13}^{S} - {α}_{13}^{C} ) & ( 15 i ) \\ {P}_{31} = {G}_{31}^{S} {V}_{33} + {V}_{31} ( {G}_{31}^{C} cos {θ}_{31} + {B}_{31}^{C} sin {θ}_{31} ) & ( 15 j ) \\ {Q}_{31} = - {B}_{31}^{S} {V}_{33} + {V}_{31} ( {G}_{31}^{C} sin {θ}_{31} - {B}_{31}^{C} cos {θ}_{31} ) & ( 15 k ) \\ {I}_{31}^{2} = {( {R}_{31}^{S} )}^{2} {V}_{33} + {( {R}_{31}^{C} )}^{2} {V}_{11} + 2 {R}_{31}^{S} {R}_{31}^{C} {V}_{31} cos ( {θ}_{31} + {α}_{31}^{S} - {α}_{31}^{C} ) & ( 15 l ) \\ {P}_{1} = {P}_{12} + {P}_{13} & ( 16 a ) \\ {Q}_{1} = {Q}_{12} + {Q}_{13} & ( 16 b ) \\ \begin{matrix}{I}_{1}^{2} = {I}_{12}^{2} + {I}_{13}^{2} + 2 {I}_{12} {I}_{13} \\ = [ {( {R}_{12}^{S} )}^{2} + {( {R}_{13}^{S} )}^{2} + 2 {R}_{12}^{S} {R}_{13}^{S} cos ( {α}_{12}^{S} - {α}_{13}^{S} ) ] {V}_{11} + {( {R}_{12}^{C} )}^{2} {V}_{22} + \\ {( {R}_{13}^{S} )}^{2} {V}_{33} + 2 {R}_{12}^{S} {R}_{12}^{C} {V}_{12} cos ( {θ}_{12} + {α}_{12}^{S} - {α}_{12}^{C} ) + \\ 2 {R}_{12}^{S} {R}_{13}^{C} {V}_{13} cos ( {θ}_{13} + {α}_{12}^{S} - {α}_{13}^{C} ) + \\ 2 {R}_{12}^{C} {R}_{13}^{S} {V}_{21} cos ( {θ}_{21} + {α}_{12}^{C} - {α}_{13}^{S} ) + \\ 2 {R}_{12}^{C} {R}_{13}^{S} {V}_{23} cos ( {θ}_{23} + {α}_{12}^{C} - {α}_{13}^{C} ) + \\ 2 {R}_{13}^{C} {R}_{13}^{C} {V}_{13} cos ( {θ}_{13} + {α}_{13}^{S} - {α}_{13}^{C} )\end{matrix} & ( 16 c ) \\ {P}_{2} = {P}_{21} + {P}_{24} & ( 16 d ) \\ {Q}_{2} = {Q}_{21} + {Q}_{24} & ( 16 e ) \\ {I}_{2}^{2} = {I}_{21}^{2} + {I}_{24}^{2} + 2 {I}_{21} {I}_{24} & ( 16 f ) \\ {P}_{3} = {P}_{31} + {P}_{35} & ( 16 g ) \\ {Q}_{3} = {Q}_{31} + {Q}_{35} & ( 16 h ) \\ {I}_{3}^{2} = {I}_{31}^{2} + {I}_{35}^{2} + 2 {I}_{31} {I}_{35} & ( 16 i ) \\ {P}_{4} = {P}_{42} & ( 16 j ) \\ {Q}_{4} = {Q}_{42} & ( 16 k ) \\ {I}_{4}^{2} = {I}_{42}^{2} & ( 16 l ) \\ {P}_{5} = {P}_{53} & ( 16 m ) \\ {Q}_{5} = {Q}_{53} & ( 16 n ) \\ {I}_{5}^{2} = {I}_{53}^{2} & ( 160 ) \\ {\underline{V}}_{i} \leq {V}_{i} \leq {\overline{V}}_{i} , i = 1 , 2 , 3 , 4 , 5 & ( 17 a ) \\ {\underline{θ}}_{i} \leq {θ}_{i} \leq {\overline{θ}}_{i} , i = 1 , 2 , 3 , 4 , 5 & ( 17 b ) \\ {\underline{P}}_{12} \leq {P}_{12} \leq {\overline{P}}_{12} & ( 17 c ) \\ {\underline{P}}_{21} \leq {P}_{21} \leq {\overline{P}}_{21} & ( 17 d ) \\ {\underline{Q}}_{12} \leq {Q}_{12} \leq {\overline{Q}}_{12} & ( 17 e ) \\ {\underline{Q}}_{21} \leq {Q}_{21} \leq {\overline{Q}}_{21} & ( 17 f ) \\ {\underline{P}}_{1} \leq {P}_{1} \leq {\overline{P}}_{1} & ( 17 g ) \\ {\underline{P}}_{2} \leq {P}_{2} \leq {\overline{P}}_{2} & ( 17 h ) \\ {s}_{12} , {s}_{24} ∈ \{ 0 , 1 \} & ( 18 )\end{matrix}$$

Constraints (15) model voltage laws, which map the voltage magnitudes and angles to branch active and reactive power flows. Constraints (16) model active-power balance and reactive-power balance at every super-node. Constraints (17) models variable box (i.e. lower bound and upper bound) constraints. Constraints (18) model the integrality constraints on a subset of variables.

Given the selected state variables, measurement functions according to an embodiment of the invention can be defined as follows:

$$\begin{matrix}{h}^{{x}_{i}} = ( {P}_{1} , {Q}_{1} , {I}_{1} ) & ( 19 a ) \\ = {P}_{h}^{{x}_{i}} {x}_{i} & ( 19 b ) \\ {h}^{{x}_{ij}} = ( {P}_{12} , {Q}_{12} , {I}_{12} , {I}_{24} , {I}_{13} , {I}_{35} ) & ( 19 c ) \\ = {P}_{h}^{{x}_{ij}} {x}_{ij} & ( 19 d ) \\ {h}^{{u}_{i}} = ( {V}_{1} , {θ}_{1} , {V}_{4} , {θ}_{4} , {V}_{5} , {θ}_{5} ) & ( 19 e ) \\ = {P}_{h}^{{u}_{i}} {u}_{i} & ( 19 f ) \\ {h}^{{u}_{ij}} = ( {s}_{24} , {s}_{35} ) & ( 19 g ) \\ = {P}_{h}^{{u}_{ij}} {u}_{ij} & ( 19 h ) \\ h = ( {h}^{{x}_{i}} , {h}^{{x}_{ij}} , {h}^{{u}_{i}} , {h}^{{u}_{ij}} ) & ( 19 i )\end{matrix}$$

which yields an additive mixture of nonlinear functions of the state variables vector and the observation errors vector:

$$\begin{matrix}{z}^{{x}_{i}} = ( {P}_{1}^{ME} , {Q}_{1}^{M} , {( {I}_{1}^{ME} )}^{2} ) & ( 20 a ) \\ = {h}^{{x}_{i}} + {v}^{{x}_{i}} & ( 20 b ) \\ {z}^{{x}_{ij}} = ( {P}_{12}^{ME} , {Q}_{12}^{M} , {I}_{13}^{ME} , {I}_{35}^{ME} ) & ( 20 c ) \\ = {h}^{{x}_{ij}} + {v}^{{x}_{ij}} & ( 20 d ) \\ {z}^{{u}_{i}} = ( {V}_{1}^{ME} , {θ}_{1}^{ME} , {V}_{4}^{ME} , {θ}_{4}^{ME} , {V}_{5}^{ME} , {θ}_{5}^{ME} ) & ( 20 e ) \\ = {h}^{{u}_{i}} + {v}^{{u}_{i}} & ( 20 f ) \\ {z}^{{u}_{ij}} = ( {s}_{24}^{ME} , {s}_{35}^{ME} ) & ( 20 g ) \\ = {h}^{{u}_{ij}} + {v}^{{u}_{ij}} & ( 20 h ) \\ z = h + v & ( 20 i ) \\ v = ( {v}^{{x}_{i}} , {v}^{{x}_{ij}} , {v}^{{u}_{i}} , {v}^{{u}_{ij}} ) & ( 20 j )\end{matrix}$$

2.2 Illustration with a Three-Phase Unbalanced System Model

Consider FIG. 4, which depicts a network unified compound it diagram. A unified power flow model according to an embodiment of the invention allows a concise exposition. If the network of FIG. 4 is one-phase only, the power and current injections are expressed as follows:

$$\begin{matrix}{P}_{ij} = {G}_{ij}^{S} {a}_{ij}^{2} {V}_{ii} + {a}_{ij} {a}_{ji} {V}_{ij} ( {G}_{ij}^{C} cos ( {θ}_{ij} + {φ}_{ij} - {φ}_{ji} ) + {B}_{ij}^{C} sin ( {θ}_{ij} + {φ}_{ij} - {φ}_{ji} ) ) & ( 21 a ) \\ {Q}_{ij} = - {B}_{ij}^{S} {a}_{ij}^{2} {V}_{ii} + {a}_{ij} {a}_{ji} {V}_{ij} ( {G}_{ij}^{C} sin ( {θ}_{ij} + {φ}_{ij} - {φ}_{ji} ) - {B}_{ij}^{C} cos ( {θ}_{ij} + {φ}_{ij} - {φ}_{ji} ) ) & ( 21 b ) \\ {I}_{ij}^{2} = {( {R}_{ij}^{S} )}^{2} {V}_{ii} + {( {R}_{ij}^{C} )}^{2} {V}_{jj} + 2 {R}_{ij}^{S} {R}_{ij}^{C} {V}_{ij} cos ( {θ}_{ij} + {α}_{ij}^{S} - {α}_{ij}^{C} ) & ( 21 c ) \\ {P}_{i} = {\sum }_{j} {P}_{ij} & ( 21 d ) \\ {Q}_{i} = {\sum }_{j} {Q}_{ij} & ( 21 e ) \\ {I}_{i}^{2} = {\sum }_{j} {I}_{ij}^{2} + 2 {\sum }_{m} {\sum }_{n > m} {I}_{im} {I}_{in} & ( 21 f )\end{matrix}$$

If the unified branch model of FIG. 4 is multi-phase, the corresponding power flows and model may be stated as follows, if iₚ,jₘ, denote phase p of node i and phase m of node j:

$$\begin{matrix}{P}_{{i}_{p} {j}_{m}} = {G}_{{i}_{p} {j}_{m}}^{S} {a}_{{i}_{p} {j}_{m}}^{2} {V}_{{i}_{p} {j}_{p}} + {a}_{{i}_{p} {j}_{m}} {a}_{{j}_{m} {i}_{p}} {V}_{{i}_{p} {j}_{m}} [ \begin{matrix}{G}_{{i}_{p} {j}_{m}}^{C} cos ( {θ}_{{i}_{p} {j}_{m}} + {φ}_{{i}_{p} {j}_{m}} - {φ}_{{j}_{m} {i}_{p}} ) + \\ {B}_{{i}_{p} {j}_{m}}^{C} sin ( {θ}_{{i}_{p} {j}_{m}} + {φ}_{{i}_{p} {j}_{m}} - {φ}_{{j}_{m} {i}_{p}} )\end{matrix} ] & ( 22 a ) \\ {Q}_{{i}_{p} {j}_{m}} = - {B}_{{i}_{p} {j}_{m}}^{S} {a}_{{i}_{p} {j}_{m}}^{2} {V}_{{i}_{p} {j}_{p}} + {a}_{{i}_{p} {j}_{m}} {a}_{{j}_{m} {i}_{p}} {V}_{{i}_{p} {j}_{m}} [ \begin{matrix}{G}_{{i}_{p} {j}_{m}}^{C} sin ( {θ}_{{i}_{p} {j}_{m}} + {φ}_{{i}_{p} {j}_{m}} - {φ}_{{j}_{m} {i}_{p}} ) - \\ {B}_{{i}_{p} {j}_{m}}^{C} cos ( {θ}_{{i}_{p} {j}_{m}} + {φ}_{{i}_{p} {j}_{m}} - {φ}_{{j}_{m} {i}_{p}} )\end{matrix} ] & ( 22 b ) \\ {I}_{{i}_{p} {j}_{m}}^{2} = {( {R}_{{i}_{p} {j}_{m}}^{S} )}^{2} {V}_{ii} + {( {R}_{{i}_{p} {j}_{m}}^{C} )}^{2} {V}_{jj} + 2 {R}_{{i}_{p} {j}_{m}}^{S} {R}_{{i}_{p} {j}_{m}}^{C} {V}_{{i}_{p} {j}_{m}} cos ( {θ}_{{i}_{p} {j}_{m}} + {α}_{{i}_{p} {j}_{m}}^{S} - {α}_{{i}_{p} {j}_{m}}^{C} ) & ( 22 c ) \\ {P}_{{i}_{p}} = {\sum }_{j} {\sum }_{m} {P}_{{i}_{p} {j}_{m}} & ( 22 d ) \\ {Q}_{{i}_{p}} = {\sum }_{j} {\sum }_{m} {Q}_{{i}_{p} {j}_{m}} & ( 22 e ) \\ {I}_{{i}_{p}}^{2} = {\sum }_{j} {\sum }_{m} {I}_{{i}_{p} {j}_{m}}^{2} + 2 {\sum }_{j} {\sum }_{k} {\sum }_{m} {\sum }_{m > n} {I}_{{i}_{p} {j}_{m}} {I}_{{i}_{p} {k}_{n}} & ( 22 f )\end{matrix}$$

Note that that EQS. (22) may be cast in a format such that the two-dimensional index space (i.e. three-phase node and phase identifier) are mapped to a one dimensional space, for example:

$$\begin{matrix}\tilde{i} = {i}_{p} & ( 23 a ) \\ = 3 i + p & ( 23 b )\end{matrix}$$

From this perspective, the aforementioned concepts and illustration, for a single-phase network model, also apply to a multi-phase network model, thereby abstracting out implementation details required for three-phase systems.

### 3 Model Solution

Concepts of new SSE algorithm according to an embodiment of the invention may be applied to 3-phase state estimation. This approximation is general enough to accommodate three-phase network AC power flow equations. An SSE model according to an embodiment of the invention is based on a novel convex approximation of the power flow constraints and objective functions. The convex approximation scheme ensures robustness. An SSE model according to an embodiment of the invention also uses a new coarse discretization of the non-linear AC voltage law, a novel branch-and-bound-and-cut discretization management scheme, and model-specific cutting planes to speed up the global solution search. An SSE model according to an embodiment of the invention can support a host of active-power, reactive-power as well as coupled active-reactive power constraints.

### 3.1 Model-Specific Interior Point Method

A SSE algorithm according to an embodiment of the invention is based on a fast and scalable primal-dual interior method, and is a fully continuous solver, applicable to a locally linearized SSE system, using matrix partitioning into ‘super-node blocks’.

### 3.1.1 Continuous SSE Model

### 3.1.1.1 Solver Model Specification

According to an embodiment of the invention, it may be assumed that an electric grid (SSE) model consists of buses iε{1,N} connected by branches ijε{1,N}×{1,N}. The connection matrix R is given as:

$${R}_{ij} = \{ \begin{matrix}1 , & if branch ij exists , \\ 0 , & otherwise .\end{matrix} \qquad ( 24 )$$

A minimal SSE model according to an embodiment of the invention assumes an AC-only grid with continuous-only state-dependent variables x and controls u. In addition to that, no thermal capacity limits are enforced on branch power flows. Finally, a discrete logic variable z defining a linearization region of originally non-convex AC voltage law constraints is assumed to be a fixed binary vector z⁰.

### 3.1.1.2 Box-Constraint Set

Two box-constraint families nay be defined that independently limit bus control vector uᵢ and dependent bus variable vector xᵢ:

x^{LB}ᵢ≦xᵢ≦xᵤ^{UB},

uᵢ^{LB}≦uᵢ≦uᵢ^{UB}. (25)

Bus control vector uᵢ typically includes voltage magnitude Vᵢ (log-scaled in this model), phase angle θᵢ, and shunt switch position Qᵢ. Bus dependent variables vector xᵢ typically includes net active xᵢ^{P} and reactive xᵢ^{Q} power injection. Similarly, a box-constraint family may be defined for branch variables that independently limit branch control vector uᵢⱼ that typically include transformer tap selection tᵢⱼ and phase shift φ_{i,}, and dependent branch variable vector that typically includes net active xᵢⱼ^{P} and reactive xᵢⱼ^{Q}:

xᵢⱼ^{LB}≦xᵢⱼ≦xᵢⱼ^{UB},

uᵢⱼ^{LB}≦uᵢⱼ≦uᵢⱼ^{Q}. (26)

### 3.1.1.3 Flow Balance Set

At every bus there must be maintained a net power injection balance between a bus and connected branches. According to an embodiment of the invention, branch dependent variables vector xᵢⱼ may be defined (typically xiⱼ=(xᵢⱼ^{P},xᵢⱼ^{Q})) and the balance specified as follows:

$${x}_{i} = {\sum }_{j = 1}^{N} {R}_{ij} \cdot {x}_{ij} \qquad ( 27 )$$

The matrix R is always highly sparse since the density of connections in real-world power grids is typically 1-5 branches per bus.

### 3.1.1.4 Discrete Control Grid

Some of the components in bus control vector uᵢ may be discrete, while the others may be continuous. According to an embodiment of the invention, a minimal discretization of the overall Cartesian product space partitions the vector uᵢ into intervals kε[1,Kᵢ] each defined by a box [uᵢₖ^{LB},uᵢₖ^{UB}], a fixed anchor vector uᵢₖ⁰ and a binary choice variable zᵢₖ. The latter is assumed fixed at zᵢₖ⁰ in a minimal SSE specification according to an embodiment of the invention. Then, discrete control grid is given by the following discrete box-constraint family:

$${\sum }_{k = 1}^{{K}_{i}} {z}_{ik}^{0} {u}_{ik}^{LB} \leq {u}_{i} \leq {\sum }_{k = 1}^{{K}_{i}} {z}_{ik}^{0} {u}_{ik}^{UB} . \qquad ( 28 )$$

Similarly, a discrete control grid may be defined for the branch control vector uᵢⱼ defined by kε[1,Kᵢⱼ] intervals each defined by a box [uᵢⱼₖ^{LB},uᵢⱼₖ^{UB}] a fixed anchor vector uᵢⱼₖ⁰ and a binary choice variable zᵢⱼₖ, assumed fixed in an embodiment at zᵢⱼₖ⁰ in this minimal SSE specification):

$${\sum }_{k = 1}^{{K}_{i}} {z}_{ijk}^{0} {u}_{ijk}^{LB} \leq {u}_{i} \leq {\sum }_{k = 1}^{{K}_{i}} {z}_{ijk}^{0} {u}_{ijk}^{UB} . \qquad ( 29 )$$

### 3.1.1.5 Discretized Voltage Law

Each interval k implies a new feasibility set xᵢⱼ^{k} for the branch power flow vector xᵢⱼ represented as a rectangle generated by intervals [uᵢₖ^{LB},uᵢₖ^{UB}], [uⱼₖ^{LB},uⱼₖ^{UB}] and [uᵢⱼₖ^{LB},uᵢⱼₖ^{UB}] following the voltage law gradient lines drawn at the combined anchor point (uᵢₖ⁰,uⱼₖ⁰,uᵢⱼₖ⁰). According to an embodiment of the invention, the set Xᵢⱼ^{k} is not specifically included in the model specification. Instead, a discretized version of an AC voltage law defining the relation between branch power flow vectors xᵢⱼ and control vectors uᵢ, uⱼ, uᵢⱼ linearized with respect to a given anchor point (uᵢ⁰,uⱼ⁰,uᵢⱼ⁰) that is typically given by the grid anchor point uᵢₖ⁰,uⱼₖ⁰,uᵢⱼₖ⁰ corresponding to zᵢₖ⁰ and zᵢⱼₖ⁰. Then, according to an embodiment of the invention the following form of a discretized AC voltage law can be assumed:

xᵢⱼ=Rij(Aᵢⱼ⁰uᵢ+Bᵢⱼ⁰uⱼ+Cᵢⱼ⁰uᵢⱼ+Dᵢⱼ⁰uⱼᵢ+Eᵢⱼ⁰) (30)

This constraint exhibits two types of sparsity: one inherited from Rᵢⱼ and the other due to dependence on only two control vectors (uᵢ, uⱼ) and (uᵢⱼ, uⱼᵢ) instead of the whole-grid control vector U=[(uᵢ)ᵢ₌₁^{N},(uᵢⱼ)_{i,j=1}^{N}]. The matrices Aᵢⱼ⁰,Bᵢⱼ⁰,Cᵢⱼ⁰,Dᵢⱼ⁰,Eᵢⱼ⁰ can be explicitly precalculated for every link (i, j) for the given anchor point) (uᵢ⁰,uⱼ⁰,uᵢⱼ⁰).

### 3.1.1.6 Objective Function

An embodiment of the invention may assume a generic convex quadratic cost function to be minimized. This function includes terms related to managing the control vector uᵢ that minimizes control adjustment costs, bus dependent variables vector xᵢ that minimize generation costs, and branch dependent variables vector xᵢⱼ that minimize transmission losses:

$$min {\sum }_{i = 1}^{N} [ \frac{1}{2} {x}_{i}^{T} {V}_{i}^{X} {x}_{i} + \frac{1}{2} {u}_{i}^{T} {V}_{i}^{U} {u}_{i} + {S}_{i}^{X} {x}_{i} + {S}_{i}^{U} {u}_{i} ] + {\sum }_{i , j = 1}^{N} {R}_{ij} [ \frac{1}{2} {x}_{ij}^{T} {W}_{ij}^{X} {x}_{ij} + \frac{1}{2} {u}_{ij}^{T} {W}_{ij}^{U} {u}_{ij} + {T}_{ij}^{X} {x}_{ij} + {T}_{ij}^{U} {u}_{ij} ] \qquad ( 31 )$$

### 3.1.1.7 Interior Point Method

First, the model is standardized to the following format:

$$min f ( x , u ) = {\sum }_{i = 1}^{N} [ \frac{1}{2} {x}_{i 1}^{T} {V}_{i}^{X} {x}_{i 1} + \frac{1}{2} {u}_{i 1}^{T} {V}_{i}^{U} {u}_{i 1} + {S}_{i 1}^{X} {x}_{i 1} + {S}_{i 1}^{U} {u}_{i 1} ] + {\sum }_{i , j = 1}^{N} {R}_{ij} [ \frac{1}{2} {x}_{i j1}^{T} {W}_{ij 1}^{X} {x}_{ij 1} + \frac{1}{2} {u}_{i j}^{T} {W}_{ij}^{U} {u}_{ij 1} + {T}_{ij 1}^{X} {x}_{ij 1} + {T}_{ij 1}^{U} {u}_{ij 1} ] \qquad ( 32 )$$

subject to:

$$\begin{matrix}{x}_{i 1} + {s}_{x i} = {x}_{i 1}^{UB} & ( 33 a ) \\ {u}_{i 1} + {s}_{u i} = {u}_{i 1}^{UB} & ( 33 b ) \\ {x}_{ij 1} + {s}_{xi j} = {x}_{ij 1}^{UB} & ( 33 c ) \\ {u}_{ij 1} + {s}_{uij} = {u}_{ij 1}^{UB} & ( 33 d ) \\ {x}_{i 1} - {\sum }_{j = 1}^{N} {R}_{ij} \cdot {x}_{ij 1} = {b}_{x} & ( 34 ) \\ {x}_{ij 1} - {R}_{ij} ( {A}_{ij}^{0} {u}_{i 1} + {B}_{ij}^{0} {u}_{j 1} + {C}_{ij}^{0} {u}_{ij 1} + {D}_{ij}^{0} {u}_{ji 1} ) = {b}_{v} & ( 35 )\end{matrix}$$

where, sₓᵢ, sᵤᵢ, sₓᵢⱼ, sᵤᵢⱼ are slack variables, and

$$\begin{matrix} {x}_{i 1} = {x}_{i} - {x}_{i}^{LB} & ( 36 ) \\ {x}_{ij 1} = {x}_{ij} - {x}_{ij}^{LB} & ( 37 ) \\ {x}_{i 1}^{UB} = {x}_{i}^{UB} - {x}_{i}^{LB} & ( 38 ) \\ {x}_{ij 1}^{UB} = {x}_{ij}^{UB} - {x}_{ij}^{LB} & ( 39 ) \\ {u}_{i 1} = {u}_{i} - max \{ {u}_{i}^{LB} , {\sum }_{k = 1}^{{K}_{i}} {z}_{ik}^{0} {u}_{ik}^{LB} \} & ( 40 ) \\ {u}_{i j 1} = {u}_{i} - max \{ {u}_{ij}^{LB} , {\sum }_{k = 1}^{{K}_{ij}} {z}_{ijk}^{0} {u}_{ijk}^{LB} \} & ( 41 ) \\ {u}_{i 1}^{UB} = min \{ {u}_{i}^{UB} , {\sum }_{k = 1}^{{K}_{i}} {z}_{ik}^{0} {u}_{ik}^{UB} \} - max \{ {u}_{i}^{LB} , {\sum }_{k = 1}^{{K}_{i}} {z}_{ik}^{0} {u}_{ik}^{LB} \} & ( 42 ) \\ {u}_{ij 1}^{UB} = min \{ {u}_{ij}^{UB} , {\sum }_{k = 1}^{{K}_{i}} {z}_{ijk}^{0} {u}_{ijk}^{UB} \} - max \{ {u}_{ij}^{LB} , {\sum }_{k = 1}^{{K}_{i}} {z}_{ijk}^{0} {u}_{ijk}^{LB} \} & ( 43 ) \\ {b}_{x} = {\sum }_{j = 1}^{N} {R}_{ij} \cdot {x}_{ij}^{LB} - {x}_{i}^{LB} & ( 44 ) \\ {b}_{v} = {R}_{ij} \cdot ( \begin{matrix}{E}_{ij 1}^{0} + {A}_{ij}^{0} max \{ {u}_{i}^{LB} , {\sum }_{k = 1}^{{K}_{i}} {z}_{ik}^{0} {u}_{ik}^{LB} \} + {B}_{ij}^{0} max \{ {u}_{j}^{LB} , {\sum }_{k = 1}^{{K}_{i}} {z}_{ik}^{0} \cdot {u}_{jk}^{LB} \} + \\ {C}_{ij}^{0} max \{ {u}_{ij}^{LB} , {\sum }_{k = 1}^{{K}_{ij}} {z}_{ijk}^{0} {u}_{ijk}^{LB} \} + {D}_{ij}^{0} max \{ {u}_{ji}^{LB} , {\sum }_{k = 1}^{{K}_{ij}} {z}_{ijk}^{0} {u}_{jik}^{LB} \}\end{matrix} ) - {x}_{ij}^{LB} & ( 45 ) \\ Let \\ v ( X ) = {x}_{ij 1} - {R}_{ij} \cdot ( {A}_{ij}^{0} \cdot {u}_{i 1} + {B}_{ij}^{0} \cdot {u}_{j 1} + {C}_{ij}^{0} \cdot {u}_{ij 1} + {D}_{ij}^{0} \cdot {u}_{ji 1} ) - {b}_{v} & ( 46 ) \\ o ( {x}_{ij} , {x}_{i} ) = {x}_{i 1} - {\sum }_{j = 1}^{N} {R}_{ij} \cdot {x}_{ij 1} - {b}_{x} & ( 47 )\end{matrix}$$

Then, for the sake of conciseness, EQS. (33), (34) and (35) as (48), (49) and (50), may be rewritten as, respectively:

X+s=X^{UB} (48)

o(X)=0 (49)

v(X)=0 (50)

The coefficients of the objective f also change:

$$\begin{matrix}{S}_{i 1}^{X} = {S}_{i}^{X} + {x}_{i}^{LB} \cdot {V}_{i}^{X} & ( 51 a ) \\ {S}_{i 1}^{U} = {S}_{i}^{U} + max \{ {u}_{j}^{LB} , {\sum }_{k = 1}^{{K}_{i}} {z}_{ik}^{0} \cdot {u}_{jk}^{LB} \} \cdot {V}_{i}^{U} & ( 51 b ) \\ {T}_{ij 1}^{X} = {T}_{ij}^{X} + {x}_{i}^{LB} \cdot {W}_{ij}^{X} & ( 51 c ) \\ {T}_{ij 1}^{U} = {T}_{ij}^{U} + max \{ {u}_{j}^{LB} , {\sum }_{k = 1}^{{K}_{i}} {z}_{ik}^{0} \cdot {u}_{jk}^{LB} \} \cdot {W}_{ij}^{U} & ( 51 d )\end{matrix}$$

By introducing logarithmic barrier terms, there is the following Lagrangian function:

L_{μ}(X,S)=f(X)−μ^{T}(ln X+ln S)−Y^{T}(X+S−X^{UB})−y₁^{T}o(xᵢⱼ,xᵢ)−y₂^{T}v(X)) (52)

Here,

X=({xᵢ₁},{xᵢⱼ₁},{uᵢ₁},{uᵢⱼ₁})^{T} (53)

S=({sₓᵢ},{sₓᵢⱼ},{sᵤᵢ},{sᵤᵢⱼ})^{T} (54)

The vectors of Lagrange multipliers Y and y are called dual variables. The KKT first order optimality conditions of the resulting system are given by EQS. (55).

$$[ \begin{matrix}∇ {L}_{X} \\ ∇ {L}_{S} \\ ∇ {L}_{Y} \\ ∇ {L}_{y 1} \\ ∇ {L}_{y 2}\end{matrix} ] = [ \begin{matrix}∇ f ( X ) - μ / X - Y - {y}_{1}^{T} ∇ o ( {x}_{ij} , {x}_{i} ) - {y}_{2}^{T} ∇ v ( X ) \\ - μ / S - Y \\ - ( X + S - {X}^{UB} ) \\ - o ( {x}_{ij} , {x}_{i} ) \\ - v ( X )\end{matrix} ] = 0 \qquad ( 55 )$$

Introducing μ/X=Zₓ, μ/S=Zₛ in EQ. (55) yields EQ. (56):

$$[ \begin{matrix}∇ {L}_{X} \\ ∇ {L}_{S} \\ ∇ {L}_{Y} \\ ∇ {L}_{y 1} \\ ∇ {L}_{y 2}\end{matrix} ] = [ \begin{matrix}∇ f ( X ) - {Z}_{x} - Y - {y}_{1}^{T} ∇ o ( {x}_{ij} , {x}_{i} ) - {y}_{2}^{T} ∇ v ( X ) \\ - {Z}_{s} - Y \\ - ( X + S - {X}^{UB} ) \\ - o ( {x}_{ij} , {x}_{i} ) \\ - v ( X ) \\ {Z}_{x} \cdot X - μ E \\ {Z}_{s} \cdot S - μ E\end{matrix} ] = 0 \qquad ( 56 )$$

Using Newton method to solve the above non-linear equation, produces the linear equation EQ. (57), where H is the Hessian matrix defined in EQ. (58).

$$\begin{matrix}H \cdot [ \begin{matrix}Δ X \\ Δ S \\ Δ Y \\ Δ {y}_{1} \\ Δ {y}_{2} \\ Δ {Z}_{x} \\ Δ {Z}_{s}\end{matrix} ] = - [ \begin{matrix}∇ f ( X ) - {Z}_{x} - Y - {y}_{1} \cdot ∇ o ( {x}_{ij} , {x}_{i} ) - {y}_{2} \cdot § v ( X ) \\ - Y - {Z}_{s} \\ - ( X + S - {X}^{UB} ) \\ - o ( {x}_{ij} , {x}_{i} ) \\ - v ( X ) \\ {Z}_{∞} \cdot X - μ E \\ {Z}_{s} \cdot S - μ E\end{matrix} ] & ( 57 ) \\ H = [ \begin{matrix}{H}_{11} & 0 & - I & {H}_{41}^{T} & {H}_{51}^{T} & - I & 0 \\ 0 & 0 & - I & 0 & 0 & 0 & - I \\ - I & - I & 0 & 0 & 0 & 0 & 0 \\ {H}_{41} & 0 & 0 & 0 & 0 & 0 & 0 \\ {H}_{51} & 0 & 0 & 0 & 0 & 0 & 0 \\ diag ( {Z}_{X} ) & 0 & 0 & 0 & 0 & diag ( X ) & 0 \\ 0 & diag ( {Z}_{S} ) & 0 & 0 & 0 & 0 & diag ( S )\end{matrix} ] \\ where & ( 58 ) \\ {H}_{11} = diag ( {V}^{x} , {W}^{x} , {V}^{u} , {W}^{U} ) , & ( 59 ) \\ {H}_{41} = [ - I , R , 0 , 0 ] & ( 60 ) \\ R = [ \begin{matrix}[ {R}_{11} I … {R}_{1 {N}_{1}} I ] & 0 & … & 0 \\ 0 & [ {R}_{21} I … {R}_{2 {N}_{2}} I ] & … & 0 \\ 0 & ⋮ & ⋱ & ⋮ \\ 0 & … & 0 & [ {R}_{{N}_{1} 1} I … {R}_{{N}_{1} {N}_{1}} I ]\end{matrix} ] \\ and & ( 61 ) \\ {( {H}_{51} )}_{ij} = [ 0 , - I , … {R}_{ij} {A}_{ij}^{0} , … {R}_{ij} {B}_{ij}^{0} , … {R}_{ij} {C}_{ij}^{0} , … {R}_{ij} {D}_{ij}^{0} , … 0 ] & ( 62 )\end{matrix}$$

Note that all four diagonal blocks in the matrix H₁₁ are themselves diagonal matrices by design, where (H₅₁)ᵢⱼ is the row of branch ij.

Defining EQ. (63), EQ. (64) follows:

$$\begin{matrix}[ \begin{matrix}∇ f ( X ) - {Z}_{x} - Y - {y}_{1}^{T} ∇ o ( {x}_{ij} , {x}_{i} ) - {y}_{2}^{T} ∇ v ( X ) \\ - Y - {Z}_{s} \\ - ( X + S - {X}^{UB} ) \\ - o ( {x}_{ij} , {x}_{i} ) \\ - v ( X ) \\ {Z}_{x} \cdot X - μ E \\ {Z}_{s} \cdot S - μ E\end{matrix} ] = [ \begin{matrix}{r}_{X} \\ {r}_{S} \\ {r}_{Y} \\ {r}_{{y}_{1}} \\ {r}_{{y}_{2}} \\ {r}_{{Z}_{x}} \\ {r}_{{Z}_{s}}\end{matrix} ] & ( 63 ) \\ [ \begin{matrix}{H}_{11} & 0 & - I & {H}_{41}^{T} & {H}_{51}^{T} & - I & 0 \\ 0 & 0 & - I & 0 & 0 & 0 & - I \\ - I & - I & 0 & 0 & 0 & 0 & 0 \\ {H}_{41} & 0 & 0 & 0 & 0 & 0 & 0 \\ {H}_{51} & 0 & 0 & 0 & 0 & 0 & 0 \\ diag ( {Z}_{X} ) & 0 & 0 & 0 & 0 & diag ( X ) & 0 \\ 0 & diag ( {Z}_{S} ) & 0 & 0 & 0 & 0 & diag ( S )\end{matrix} ] [ \begin{matrix}Δ X \\ Δ S \\ Δ Y \\ Δ {y}_{1} \\ Δ {y}_{2} \\ Δ {Z}_{x} \\ Δ {Z}_{s}\end{matrix} ] = - [ \begin{matrix}{r}_{X} \\ {r}_{S} \\ {r}_{Y} \\ {r}_{{y}_{1}} \\ {r}_{{y}_{2}} \\ {r}_{{Z}_{x}} \\ {r}_{{Z}_{s}}\end{matrix} ] & ( 64 )\end{matrix}$$

To solve the Newton equations, the dimension can be reduced as follows. From the last two equations, there is:

ΔZₓ=diag(X)⁻¹(−T_{Z}_{ₓ}−diag(Zₓ)ΔX) (65)

ΔZₛ=diag(S)⁻¹(−T_{Z}_{ₛ}−diag(Zₛ)ΔS) (66)

Substituting for the other equations and re-organizing the equations into primal and dual parts yields EQ. (67).

$$\begin{matrix}[ \begin{matrix}{H}_{41} & 0 & \vert & 0 & 0 & 0 \\ {H}_{51} & 0 & \vert & 0 & 0 & 0 \\ - I & - I & \vert & 0 & 0 & 0 \\ \_ & \_ & & \_ & \_ & \_ \\ {H}_{11} + {diag ( X )}^{- 1} diag ( {Z}_{x} ) & 0 & \vert & - I & {H}_{41}^{T} & {H}_{51}^{T} \\ 0 & {diag ( S )}^{- 1} diag ( {Z}_{s} ) & \vert & - I & 0 & 0\end{matrix} ] [ \begin{matrix}Δ X \\ Δ S \\ \_ \\ Δ Y \\ Δ {y}_{1} \\ Δ {y}_{2}\end{matrix} ] = [ \begin{matrix}- {r}_{y 1} \\ - {r}_{y 2} \\ - {r}_{Y} \\ \_ \\ - {r}_{x} - {diag ( X )}^{- 1} {r}_{{Z}_{x}} \\ - {r}_{s} - {diag ( S )}^{- 1} {r}_{{Z}_{s}}\end{matrix} ] & ( 67 ) \\ Defining \\ {\tilde{H}}_{11} = {H}_{11} + {diag ( X )}^{- 1} diag ( {Z}_{x} ) & ( 68 a ) \\ {\tilde{H}}_{22} = {diag ( S )}^{- 1} diag ( {Z}_{S} ) & ( 68 b ) \\ {\tilde{r}}_{x} = {r}_{x} + {diag ( X )}^{- 1} {r}_{{Z}_{x}} & ( 68 c ) \\ {\tilde{r}}_{s} = {r}_{s} + {diag ( S )}^{- 1} {r}_{{Z}_{s}} & ( 68 d ) \\ Δ X = [ \begin{matrix}\{ Δ {x}_{i} \} \\ \{ Δ {x}_{ij} \} \\ \{ Δ {u}_{ij} \} \\ \{ Δ {u}_{ij} \}\end{matrix} ] & ( 68 e ) \\ Δ {y}_{1} = \{ Δ {y}_{1}^{{x}_{i}} \} & ( 68 f ) \\ Δ {y}_{2} = \{ Δ {y}_{2}^{{x}_{ij}} \} & ( 68 g )\end{matrix}$$

Therefore, one can have

$$\begin{matrix}[ \begin{matrix}{H}_{41} & 0 \\ {H}_{51} & 0 \\ - I & - I\end{matrix} ] [ \begin{matrix}Δ X \\ Δ S\end{matrix} ] = [ \begin{matrix}- {r}_{{y}_{1}} \\ - {r}_{{y }_{2}} \\ - {r}_{Y}\end{matrix} ] & ( 69 ) \\ [ \begin{matrix}{\tilde{H}}_{11} & 0 \\ 0 & {\tilde{H}}_{22}\end{matrix} ] [ \begin{matrix}Δ X \\ Δ S\end{matrix} ] + [ \begin{matrix}- I & {H}_{41}^{T} & {H}_{51}^{T} \\ - I & 0 & 0\end{matrix} ] ⌊ \begin{matrix}Δ Y \\ Δ {y}_{1} \\ Δ {y}_{2}\end{matrix} ⌋ = [ \begin{matrix}- {\tilde{r}}_{x} \\ - {\tilde{r}}_{s}\end{matrix} ] & ( 70 )\end{matrix}$$

### 3.1.2 Discrete SSE Model

An AC (SSE) model according to an embodiment of the invention assumes AC-only grid with state-dependent integer variable z and continuous variable x and controls u. In addition to that, no thermal capacity limits are enforced on branch power flows. The interior point cutting plane method (IPCPM), which possesses the advantages of both the interior pint method and the cutting plane method, becomes a suitable approach to a large-scale and mixed-integer SSE according to an embodiment of the invention. It employs a successive linearization and convexification process and iteratively solves the mixed integer linear program.

The cutting plane method is widely used to solve mixed-integer systems. However, a direct application of an existing cutting plane method to an SSE model according to an embodiment of the invention is problematic because of the following two reasons. Firstly, it is questionable whether and how well current cutting plane methods can handle a large-scale system. Secondly, an SSE model according to an embodiment of the invention is highly structural, which means every constraint is quite local and is with respect to only one node or branch. This sparsity structure is crucial for an interior point solver to work efficiently. Therefore, the cutting plane needs to be adaptive to the structure, i.e. it should also be a local constraint within a single node or branch and can be easily put into recursive computation. From this point of view, a straightforward use of a conventional cutting plane is improper since it requires computing an inverse matrix which will very likely destroy the sparsity structure.

According to an embodiment of the invention, a class of mixed-rounding cutting planes are provided which are suitable to an SSE model according to an embodiment of the invention and the main procedure for each iteration. In each iteration, a class of cutting planes is generated. The cutting plane can be either generic basis-independent or basis dependent. Both of them are only based on local information, i.e. constraints of a single branch.

### 3.1.2.1 SSE Model Specification

The original SSE model according to an embodiment of the invention is a nonlinear, nonconvex, mixed-integer large-scale model. Introducing certain convexification and linearization techniques yields a simplied linear program. According to an embodiment of the invention, it may be assumed that there are continuous state-dependent variables x and controls u that are always nonnegative.

### 3.1.2.2 Node Constraints

According to an embodiment of the invention, the following box-constraint family and flow balance constraints are defined for node i:

$$\begin{matrix}{x}_{i}^{LB} \leq {x}_{i} \leq {x}_{i}^{UB} & ( 71 a ) \\ {x}_{i} = {\sum }_{j = 1}^{N} {R}_{ij} \cdot {x}_{ij} & ( 71 b )\end{matrix}$$

The node constraints are only a small part among all constrains of an SSE model according to an embodiment of the invention. The major and key part is the branch constraints described next.

### 3.1.2.3 Branch Constraints

To reformulate a convex set of branch constraints, predefined anchor vectors u_{i,k}⁰,u_{j,k}⁰,u_{ij,k}⁰,u_{ji,k}⁰ may be introduced for each branch (i, j). Accordingly, there are also 0-1 control variables z_{i,k}⁰,z_{j,k}⁰,z_{ij,k}⁰,z_{ji,k}⁰ to specify the anchor point around which the linearization is preformed. Therefore with predefined box constraints u_{i,k}^{UB(LB)},u_{j,k}^{UB(LB)},u_{ij,k}^{UB(LB)},u_{ji,k}^{UB(LB)}, there are the following constrains for branch (i, j)

$$\begin{matrix}{\sum }_{k = 1}^{{K}_{i}} {z}_{i , k}^{0} \cdot {u}_{i , k}^{LB} \leq {u}_{i} \leq {\sum }_{k = 1}^{{K}_{i}} {z}_{i , k}^{0} \cdot {u}_{i , k}^{UB} & ( 72 a ) \\ {\sum }_{k = 1}^{{K}_{j}} {z}_{j , k}^{0} \cdot {u}_{j , k}^{LB} \leq {u}_{j} \leq {\sum }_{k = 1}^{{K}_{j}} {z}_{j , k}^{0} \cdot {u}_{j , k}^{UB} & ( 72 b ) \\ {\sum }_{k = 1}^{{K}_{ij}} {z}_{ij , k}^{0} \cdot {u}_{ij , k}^{LB} \leq {u}_{ij} \leq {\sum }_{k = 1}^{{K}_{ij}} {z}_{ij , k}^{0} \cdot {u}_{ij , k}^{UB} & ( 72 c ) \\ {\sum }_{k = 1}^{{K}_{ji}} {z}_{ji , k}^{0} \cdot {u}_{ji , k}^{LB} \leq {u}_{ji} \leq {\sum }_{k = 1}^{{K}_{ji}} {z}_{ji , k}^{0} \cdot {u}_{ji , k}^{UB} & ( 72 d ) \\ {x}_{ij}^{LB} \leq {x}_{ij} \leq {x}_{ij}^{UB} & ( 72 e ) \\ {\sum }_{k = 1}^{{K}_{i}} {z}_{i , k}^{0} = 1 & ( 72 f ) \\ {\sum }_{k = 1}^{{K}_{j}} {z}_{j , k}^{0} = 1 & ( 72 g ) \\ {\sum }_{k = 1}^{{K}_{ij}} {z}_{ij , k}^{0} = 1 & ( 72 h ) \\ {z}_{i , k}^{0} , {z}_{j , k}^{0} , {z}_{ij , k}^{0} ∈ \{ 0 , 1 \} & ( 72 i ) \\ {x}_{ij} = {R}_{ij} \cdot ( {A}_{ij}^{0} \cdot {u}_{i} + {B}_{ij}^{0} \cdot {u}_{j} + {C}_{ij}^{0} \cdot {u}_{ij} + {D}_{ij}^{0} \cdot {u}_{ji} + {E}_{ij}^{0} ) . & ( 73 )\end{matrix}$$

### 3.1.2.4 Interior Point Method

A discrete SSE model formulation according to an embodiment of the invention is a generalization of ae continuous SSE formulation according to an embodiment of the invention, with the addition of discrete variables. An interior point method according to an embodiment of the invention for a discrete SSE formulation is a generalization of the interior point method for the continuous SSE formulation, and follows the same derivation as above, taking account of the additional discrete variables.

### 3.2 SSE Iterative Convex Approximation

An SSE model according to an embodiment of the invention is based on a novel convex approximation of the power flow constraints and objective functions. Note that the SE model is defined by the network topology, the state vector, the measurement vector, the network model and the measurement functions. The measurement function is a projection of the network model functions. The convex approximation applies to the network functions. Hence, a convex approximation may be developed for the SE model. According to an embodiment of the invention, the SE voltage law relations can be reformulated using complex plane representation such that it leads to a convex representation of the feasibility set for branch power flows Pᵢⱼ, Qᵢⱼ. The quality of convex approximation can be managed by properly adding more anchor points for branch voltages and phase angle difference. According to an embodiment of the invention, an MIP heuristic can be used to control this process in run-time. The heuristic is based on branch-and-cut mechanism and uses constraint infeasibility as the primal indicator for placing new anchor points. First of all, introduce a complex branch flow:

Fᵢⱼ=Pᵢⱼ+iQᵢⱼ (74)

Note that the voltage law relations include two terms:

a self-admittance term that only depends on single bus voltage; and

a cross-admittance term that depends on phase angles and cross-product of voltages

Thus, the complex branch flow can be represented as:

Fij=Fᵢⱼ^{S}+Fᵢⱼ^{C} (75)

The Euler representation of complex numbers in polar coordinates is used for both self- and cross-admittance terms:

Fᵢⱼ^{C}=exp(Tᵢⱼ^{C}+i(θᵢ−θⱼ−αᵢⱼ^{C})) (76)

Fᵢⱼ^{S}=exp(Tᵢⱼ^{S}+i(−αᵢⱼ^{S})) (77)

The modules rᵢⱼ^{C} and rᵢⱼ^{S} are driven by both voltages and admittances:

Tᵢⱼ^{C}=ln Vᵢ+ln aᵢⱼ+ln Vⱼ+ln aⱼᵢ+ln Rᵢⱼ^{C} (78)

Tᵢⱼ^{S}=ln Vᵢ+ln aᵢᵢ+ln Vᵢ+ln aᵢᵢ+ln Rᵢⱼ^{S} (79)

where Rᵢⱼ^{S},Rᵢⱼ^{C},αᵢⱼ^{S},αᵢⱼ^{C} are driven by admittances only:

$$\begin{matrix}{R}_{ij}^{S} = {[ {( {G}_{ij}^{S} )}^{2} + {( {B}_{ij}^{S} )}^{2} ]}^{\frac{1}{2}} & ( 80 ) \\ {R}_{ij}^{C} = {[ {( {G}_{ij}^{C} )}^{2} + {( {B}_{ij}^{C} )}^{2} ]}^{\frac{1}{2}} & ( 81 ) \\ {α}_{ij}^{S} = arcsin ( {B}_{ij}^{S} / {R}_{ij}^{S} ) & ( 82 ) \\ {α}_{ij}^{C} = arcsin ( {B}_{ij}^{C} / {R}_{ij}^{C} ) & ( 83 )\end{matrix}$$

We switch to logs of bus voltages (equivalent to measure them in logarithmic scale). This transformation does not introduce new non-linearity into the model since the voltages only have box constraints.

Note that the voltage tensor product is now a linear sum in the expression for the modules rᵢⱼ^{C} and rᵢⱼ^{S}. Thus, a transformation introduces an easy way to preserve the Rank 1 property of the voltage tensor product.

Note that the chosen transformer taps (in the log scale) also appear linearly in the in the expression for the modules. Thus, a transformation according to an embodiment of the invention creates a new way to introduce a binary transformer tap choice, similar to that of the switching shunts and phase shift. This eliminates the need for an inflated set of transformer constraints in an SSE model formulation according to an embodiment of the invention and MIP enforcement of the binary choice performs much faster for this reformulation.

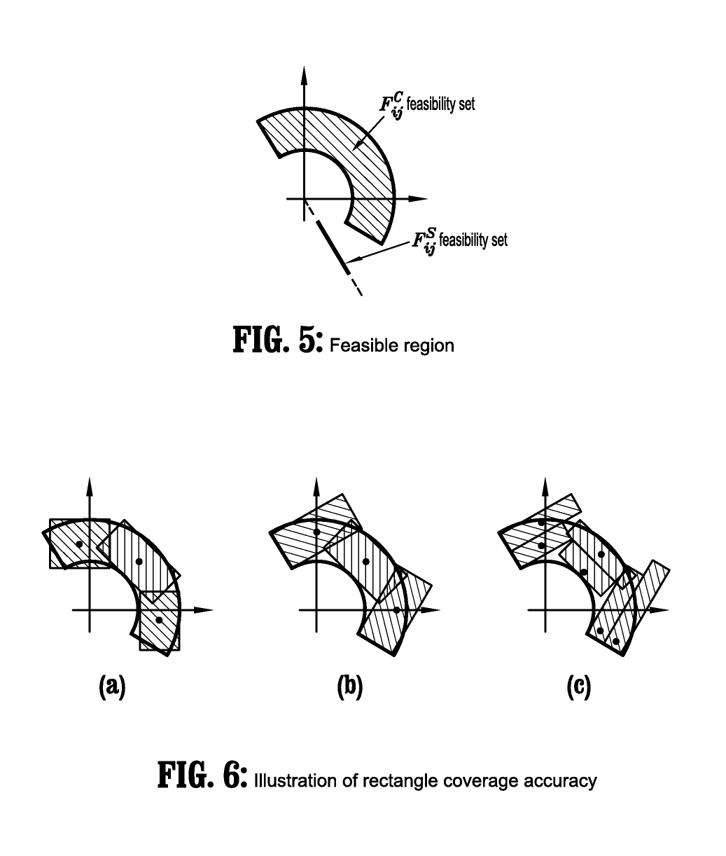

FIG. 5 illustrates the forms of the feasibility sets of Fᵢⱼ^{S} and Fᵢⱼ^{C} on the complex plane. The feasibility set for Fᵢⱼ^{S} is a line, because the phase angle is fixed to be equal to −αᵢⱼ^{S}. The feasibility set for Fᵢⱼ^{C} is a sector of a ring provided by box intervals for its radius and angle.

The former tap choice implies different sectors and basically weighing them with exclusive binary choice variables.

Overall, the feasibility set of the Fᵢⱼ and, due to the power flow conservation constraint, the net power injection, Pᵢ+iQᵢ becomes a weighted sum of different ring sectors on the complex plane.

A ring sector is not a convex set. Thus, a sum of ring sectors is not a convex set. Moreover, such sum may take various geometric forms on the complex plane comprising pieces of ring sectors; that is, very unsystematic and highly non-convex.

However, it is easy to convexify a ring sector if its angle span is small: pick a middle point and cover it with a rectangle formed by the ring's tangent lines (at the middle point). Then, large-span sector is a combination of several disjoint small sectors and each of them can be covered by such a rectangle. Therefore, any ring sector can be covered with a high accuracy by a combination of properly centered, scaled and oriented rectangles.

The degree of coverage accuracy can be controlled by increasing the number of rectangles and also by their placement. Theoretically speaking, a ring sector could be convexified by any other convex geometric shapes coverage, so that convexification is similar to, say, triangulation of the ring sector. However, triangulation in general is a hard and numerically costly task while rectangulation is a natural choice for ring sector coverage and rectangles are very easy and numerically inexpensive to generate via tangent lines and polar coordinate intervals. FIG. 6 illustrates the idea of different rectangle coverage accuracy. Each black dot in FIG. 6 represents the anchor point for the corresponding rectangle.

Note that increasing the number of rectangles often does not lead to higher accuracy. Thus, proper placement of just a few anchor points can be the best coverage. Moreover, the whole coverage may not be needed right at the beginning of the solution process and new anchor points may be added in the solution run-time in case the solver finds it useful to place a new rectangle in the uncovered region. This is the core idea of an MIP heuristic according to an embodiment of the invention for placing new anchor points.

If each sector is covered by rectangles and there is a selection process for the rectangles within a sector such that only one of the rectangles is chosen at a time, then the feasibility set of Fᵢⱼ and, due to the Power Flow Conservation constraint, the net power injection, Pᵢ+iQᵢ, becomes a sum of rectangles, that is, a convex set, due to the preservation of convexity through set sum process. Thus, the overall SSE model can be convexified.

In the simple case where rectangles are generated by tangent lines and polar coordinate intervals, Voltage Law convexification is equivalent to a first-order approximation of the Euler representation's exponent for the complex power flow Fᵢⱼ in the neighborhood of the given anchor point (\tilde{P}ᵢⱼ,\tilde{Q}ᵢⱼ):

$$\begin{matrix}{F}_{ij}^{s} = {\tilde{F}}_{ij}^{s} + \frac{\partial {\tilde{F}}_{ij}^{s}}{\partial {v}_{i}} ( {v}_{i} - {\tilde{v}}_{i} ) + \frac{\partial {\tilde{F}}_{ij}^{s}}{\partial {v}_{j}} ( {v}_{j} - {\tilde{v}}_{j} ) + \frac{\partial {\tilde{F}}_{ij}^{s}}{\partial {θ}_{i}} ( {v}_{i} - {\tilde{θ}}_{i} ) + \frac{\partial {\tilde{F}}_{ij}^{s}}{\partial {θ}_{j}} ( {θ}_{j} - {\tilde{θ}}_{j} ) & ( 84 ) \\ {F}_{ij}^{c} = {\tilde{F}}_{ij}^{c} + \frac{\partial {\tilde{F}}_{ij}^{c}}{\partial {v}_{i}} ( {v}_{i} - {\tilde{v}}_{i} ) + \frac{\partial {\tilde{F}}_{ij}^{c}}{\partial {v}_{j}} ( {v}_{j} - {\tilde{v}}_{j} ) + \frac{\partial {\tilde{F}}_{ij}^{c}}{\partial {θ}_{i}} ( {v}_{i} - {\tilde{θ}}_{i} ) + \frac{\partial {\tilde{F}}_{ij}^{c}}{\partial {θ}_{j}} ( {θ}_{j} - {\tilde{θ}}_{j} ) & ( 85 ) \\ {A}_{ij} = [ \begin{matrix}2 {\tilde{P}}_{ij}^{s} + {\tilde{P}}_{ij}^{c} & - {\tilde{Q}}_{ij}^{c} \\ 2 {\tilde{Q}}_{ij}^{s} + {\tilde{Q}}_{ij}^{c} & {\tilde{P}}_{ij}^{c}\end{matrix} ] & ( 86 ) \\ {B}_{ij} = [ \begin{matrix}{\tilde{P}}_{ij}^{c} & {\tilde{Q}}_{ij}^{c} \\ {\tilde{Q}}_{ij}^{c} & {\tilde{- P}}_{ij}^{c}\end{matrix} ] & ( 87 ) \\ {E}_{ij} = [ \begin{matrix}{E}_{ij 1} \\ {E}_{ij 2}\end{matrix} ] \\ where & ( 88 ) \\ {E}_{ij 1} = {\tilde{P}}_{ij}^{s} + {\tilde{P}}_{ij}^{c} - 2 {\tilde{v}}_{i} {\tilde{P}}_{ij}^{s} - {\tilde{P}}_{ij}^{c} ( {\tilde{v}}_{i} + {\tilde{v}}_{j} ) + {\tilde{Q}}_{ij}^{c} ( {\tilde{θ}}_{i} - {\tilde{θ}}_{j} ) & ( 89 ) \\ {E}_{ij 2} = {\tilde{Q}}_{ij}^{s} + {\tilde{Q}}_{ij}^{c} - 2 {\tilde{v}}_{i} {\tilde{Q}}_{ij}^{s} - {\tilde{Q}}_{ij}^{c} ( {\tilde{v}}_{i} + {\tilde{v}}_{j} ) + {\tilde{P}}_{ij}^{c} ( {\tilde{θ}}_{i} - {\tilde{θ}}_{j} ) & ( 90 )\end{matrix}$$

This linearization is similar to an SLP linearization except that it uses log-scale voltages and transformer taps and thus it preserves the voltage tensor product Rank 1 property.

In the simplest case where only one anchor point is used, this approximation is similar to the DC representation of the SSE problem, except that it consider voltages as variables, not fixed as in conventional DC approximation schemes.

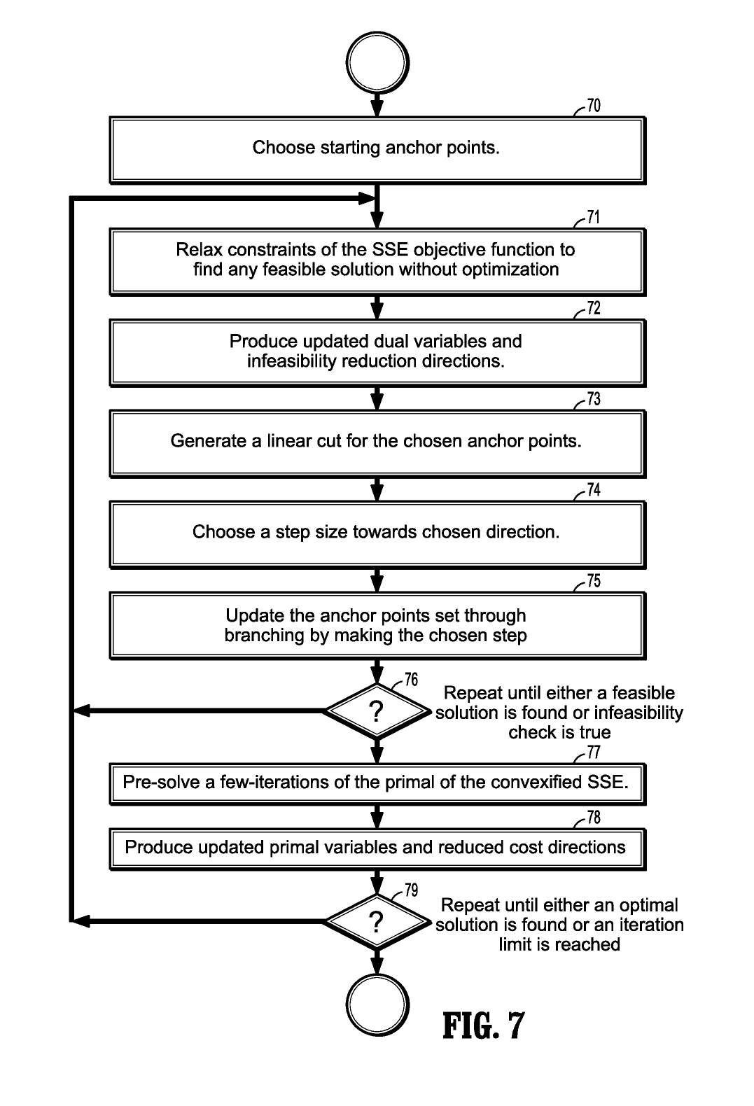

In general case, an MIP heuristic according to an embodiment of the invention can manage a solution process by placing anchor points and generating a covering of the SSE model feasible region with rectangles according to the following work flow, illustrated in the flow chart of FIG. 7:
(1) Choose starting anchor points (step 70).
(2) Pre-solve a few-iterations of the dual of the convexified SSE by relaxing constraints due to the SSE objective function (i.e. solving for any feasible solution without optimization) (step 71)
(3) Produce updated dual variables and infeasibility reduction directions (Step 72).
(4) Generate a linear cut for the chosen anchor points (step 73).
(5) Choose a step size towards chosen direction (step 74).
(6) Update the anchor points set through branching by making the chosen step (Step 75).
(7) Go back to step 2 until either a feasible solution is found or infeasibility check is true (Step (76).
(8) Pre-solve a few iterations of the primal of the convexified SSE (Step 77).
(9) Produce updated primal variables and reduced cost directions (Step 78).
(10) Go back to the step 4 unless either an optimal solution is found or an iteration limit is reached (Step 79).

This process resembles an SLP process, however a branch-and-cut mechanism is used instead of penalties. Branching ensures that the previously checked anchor points are not discarded but rather are traversed in a tree-like recursive way. Cutting provides a way to discard anchor points that are checked to be infeasible or inferior.

There other non-convex relations in an SSE model according to an embodiment of the invention, such as Branch Flow Cone (BFC) and Branch Flow Bilinear (BFB) constraints as well as Converter equations. BFC is convex constraint and thus can be included to the convexified SSE without any modifications. BFB is not convex and is due to branch capacity lower bound, and may be ignored.

Converter relations are a bit more challenging but can be convexified and managed by the same MIP process according to an embodiment of the invention though the quality of approximation may be lower due to some necessary simplification assumptions. However, realistic cases the fraction of Converter components is negligibly small compared to AC and DC nodes so that the approximation accuracy is not crucial.

### 3.3 Branch-and-Bound-and-Cut Discretization Management

To illustrate the concept of branch-and-bound, consider the following linear mixed-integer program.

min100x₁−72x₂−36x₃ (91a)

s.t.−2x₁+x₂≦0 (91b)

−4x₁+x₃≦0 (91c)

x₁+x₂≦1 (91d)

x₁,x₂,x₃ε{0,1} (91e)

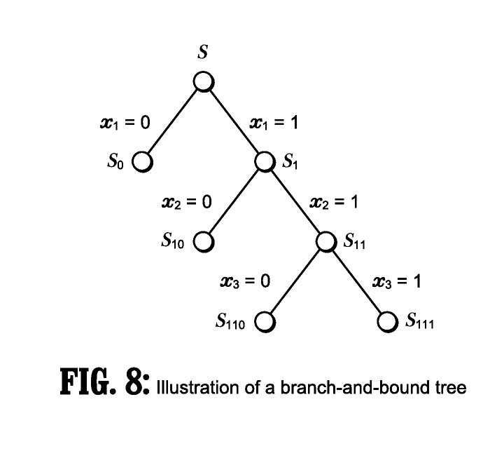

FIG. 8 shows a branch-and-bound tree of EQS. (91), where S_{α} denotes a feasible after fixing a subset of the binary variables to non-fractional values.

Note that an infeasibility condition holds for S₀:

$$\begin{matrix}{S}_{0} = \{ x \text{:} {x}_{1} = 0 , {x}_{2} \leq 0 , {x}_{3} \leq 0 , {x}_{2} + {x}_{3} \geq 1 \} & ( 92 ) \\ = ∅ . & ( 93 )\end{matrix}$$

Let z₁₀, z₁₁₀ and z₁₁₁ denote the objective values of a reduced linear program on the subset S₁₀, S₁₁₀ and S₁₁₁, respectively:

z₁₁₁=−8≦x₁₁₀=28≦z₁₀=64 (94)

The solution of EQS. (91) is x₁=1, x₂=1, and x₃=1.

Consider the following MILP:

$$\begin{matrix}{max}_{x 1 , x 2} γ = {c}_{1}^{T} {x}_{1} + {c}_{2}^{T} {x}_{2} & ( 95 a ) \\ s . t . {A}_{1} {x}_{1} + {A}_{2} {x}_{2} = b & ( 95 b ) \\ {x}_{1} ∈ {\{ 0.1 \}}^{q} , {x}_{2} \geq 0 & ( 95 c )\end{matrix}$$

where x₁ and x₂ denote vectors of binary and fractional decision variables, respectively, in EQS. (95).

Let X denote the feasible region of EQS. (95) and C, its convex hull. Assume that an appropriate data structure, denoted N, is used to store the nodes generated through a branch-and-cut procedure. Further, let N denote the index set of N; that is, nεN is an active branch-and-cut node at the current stage of the algorithm.

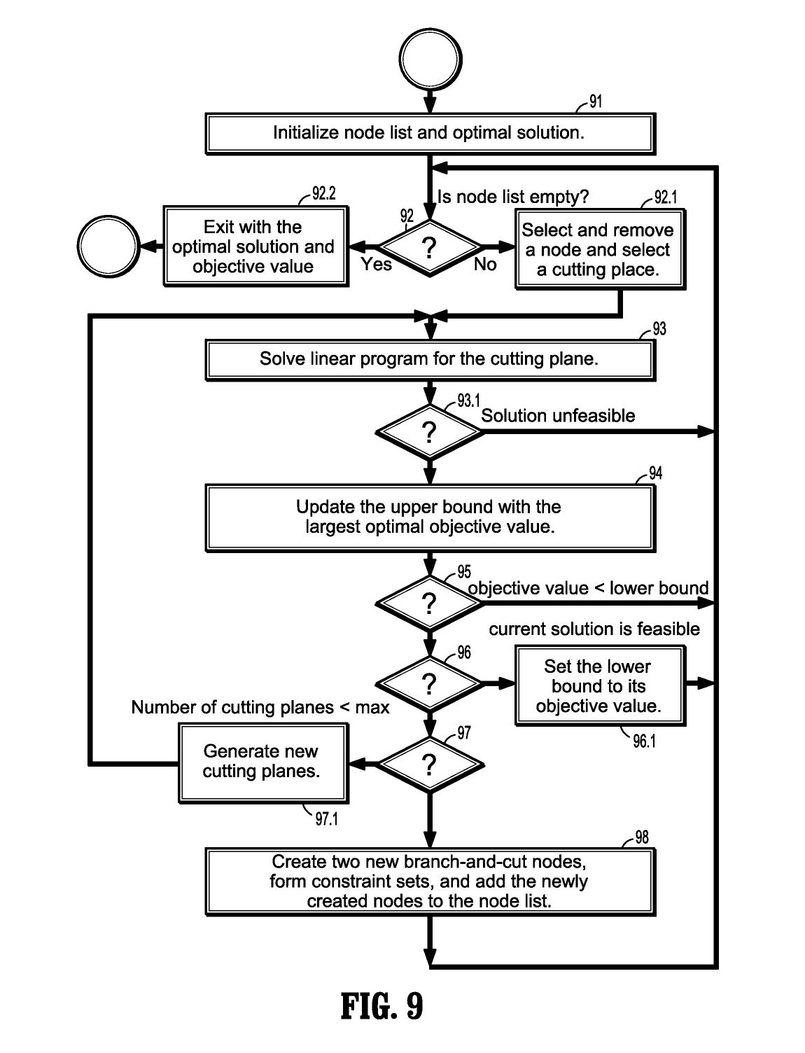

A branch-and-cut algorithm is a branch-and-bound procedure with cutting planes. A branch-and-cut algorithm according to an embodiment of the invention is outlined as follows, and illustrated in the flow chart of FIG. 9:
(1) (Initialization) (Step 91) Initialize node list N with the original, possibly preprocessed, linear relaxation max{c^{T}x: xεC}, and optimal solution (x₁*,x₂*) with the empty element. Set γ*:=−∞ and γ̅*̅:=+∞.
(2) If N is empty (Step 92), set (Step 92.2) γ*=γ*, (x₁*,x₂*)=(\hat{x}₁*,\hat{x}₂*), exit with the optimal solution (x₁*,x₂*) and objective value γ*. Else, (Step 92.1) select and remove a node, n, from N; set k:=1, mₙ=0 and cutting plane Cₙₖ:=Cₙ.
(3) (LP relaxation) (Step 93) Solve the linear program max {c^{T}x: xεCₙₖ} and store its objective value in γₙₖ. If γₙₖ=−∞ (i.e. if max {c^{T}x: xεCₙₖ} is infeasible) (Step 93.1), go to step 2.
(4) (Updating upper bound) (Step 94) Store an optimal solution in (x₁^{nk},x₂^{nk}) and update γ̅* with the largest optimal objective value for a linear-programming relaxation among all current active branch-and-cut nodes.
(5) (Pruning) If γₙₖ≦γ*(Step 95), go to step 2.
(6) (Updating lower bound) If (x₁^{nk},x₂^{nk}) is feasible in EQS. (95); that is, if (x₁^{nk},x₂^{nk})εX (Step 96), set (Step 96.1) γ̅*̅=γₙₖ, \hat{x}₁*,\hat{x}₂*)=(x₁^{nk},x₂^{nk}), and go to step 2.
(7) (Cut generation) If mₙ≦ m̅ₙ (Step 97), go to step 8. Else, (Step 97.1) solve the separation to generate a finite number mₙₖ of valid inequalities (or cutting planes), Aₙ₍ₖ₊₁₎x≦bₙ₍ₖ₊₁), for Cₙₖ. If mₙₖ≦1, mₙ+=mₙₖ, add the new mₙₖ inequalities to Cₙₖ producing a tighter feasible region Cₙ₍ₖ₊₁₎=Cₙₖ∩{x: Aₙ₍ₖ₊₁₎x≦bₙ₍ₖ₊₁₎}; set k+=1; go to step 3.
(8) (Branching) (Step 98) Choose a fractional scalar variable, x₁ₗ, from the sub-vector x₁, and create two new branch-and-cut nodes. Index the two new nodes by n̅+1 and n̅+2, respectively. Add the rounding constraints xᵢₗ≦└x₁ₗ^{nk}┘ for one node, and x₁ₗ≧|x₁ₗ^{nk}| for the other node, forming the constraint sets C_{( n̅+1)} and C_{( n̅+2)}.

Add the newly created nodes to the node list N; set n̅=2. Go to step 2.

Note that the rounding constraints together with the binary nature of the components of the (optimal) subvector x₁ in EQS. (95) can be equivalently reduced to x₁ₗ=0 and x₁ₗ=1, respectively. Hence the branching step can be viewed as a variable fixing step.

### 3.4 Solution Initialization Strategies

An SSE according to an embodiment of the invention can support four solution initialization strategies, which will prove particularly helpful for DSE, namely full warm-start, partial warm-start, partial cold-start and full coldstart, as outlined below.

Full Warm-Start:

This initialization strategy yields a very fast SSE solution. The full warm-start applies if no island or bus split occurs. This strategy uses the pre-SSE state to warm-start the continuous solver for linearized SSE.

Partial Warm-Start:

This initialization strategy yields a fast SSE solution. The partial warm-start applies if a switching event occurs with no island or bus split. This strategy uses local discrete event identification procedure, applies identified discrete event as a hot-fix of the state vector, then uses the updated state to warm-start the continuous solver for linearized SSE.

Partial Cold-Start:

This initialization strategy yields an SSE solution that may take a few extra seconds. The partial cold-start applies if a localized bus or island split occurs. This solution strategy uses the continuous parametric relaxation of SSE topology, updates the state vector to warm-start the continuous solver, introduces a handful of discretization points for the network with local topology change, and allows a few branch-and-cut iterations.

Full Cold-Start:

This initialization strategy yields an SSE that is more CPU intensive. The full cold-start applies if no warm-start information is re-usable. This solution strategy uses only new information (i.e. topology from NTP), introduces coarse discretization of every bottle-neck node/link, and allows enough branch-and-cut iterations to get a solution.

### 4 System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

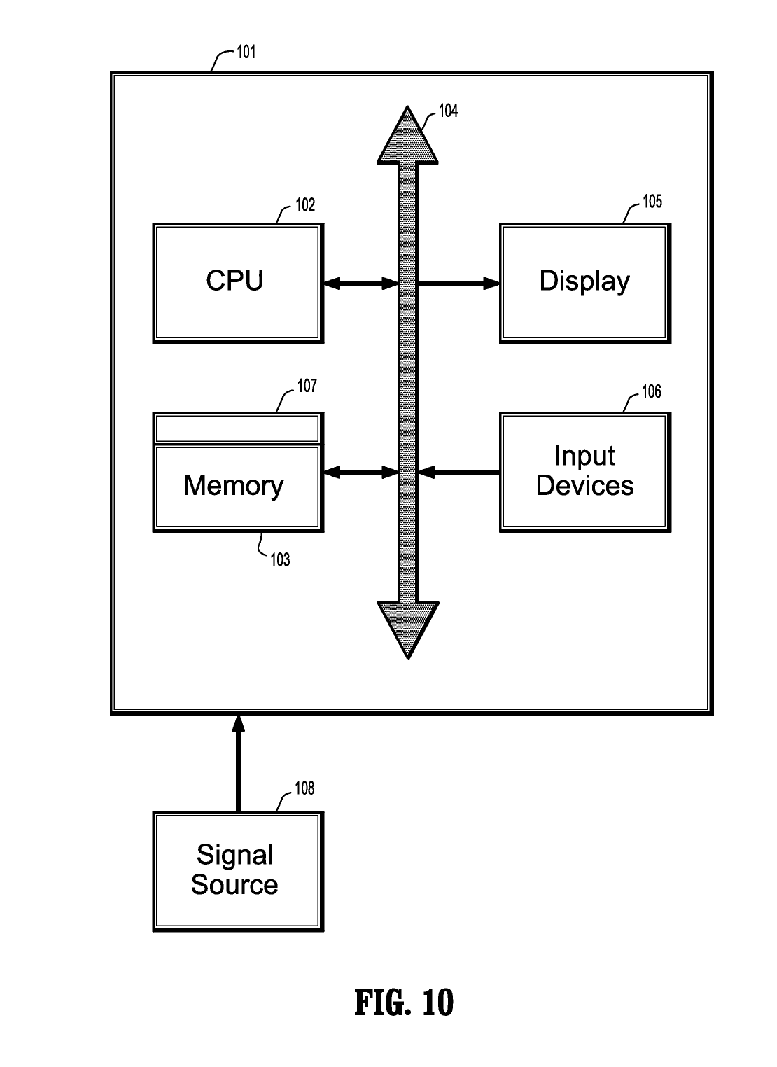

FIG. 10 is a block diagram of an exemplary computer system for implementing an (SSE)-model-specific interior-point and cutting-plane method for state estimation in a distribution network according to an embodiment of the invention. Referring now to FIG. 10, a computer system 101 for implementing the present invention can comprise, inter alia, a central processing unit (CPU) 102, a memory 103 and an input/output (I/O) interface 104. The computer system 101 is generally coupled through the I/O interface 104 to a display 105 and various input devices 106 such as a mouse and a keyboard. The support circuits can include circuits such as cache, power supplies, clock circuits, and a communication bus. The memory 103 can include random access memory (RAM), read only memory (ROM), disk drive, tape drive, etc., or a combinations thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer system 101 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A method approximating a solution of a stochastic state estimation (SSE) model of an electric grid, comprising the steps of:
(1) choosing starting anchor points in an SSE model of an electric grid;
(2) relaxing constraints of an SSE objective function to solve for a feasible solution of the SSE model;
(3) calculating updated dual variables and infeasibility reduction directions from the feasible solution;
(4) generating a linear cut for the chosen starting anchor points;
(5) choosing a step size toward the reduction directions; and
(6) updating the anchor points through branching by making the chosen step, wherein each anchor point defines a rectangle that at least partially covers a feasible solution set of the SSE model, wherein each rectangle is a convex set, and the set of rectangles covering the feasible solution set of the SSE model define an approximate solution of the SSE model of said electric grid.

2. The method of claim 1, further comprising (7) repeating steps (2) through (6) until either a feasible solution is found or an infeasibility check is true.

3. The method of claim 2, further comprising (8) pre-solving a few-iterations of a primal of a convexified SSE model.

4. The method of claim 3, further comprising (9) calculating updated primal variables and reduced cost directions.

5. The method of claim 4, further comprising (10) repeating steps (4) through (9) until either an optimal solution is found or an iteration limit is reached.

6. A method of finding an optimal solution of a stochastic state estimation (SSE) model of an electric grid, comprising the steps of:
(1) providing a convexified SSE model of an electric grid, said convexified SSE model including an objective function having an objective value, a plurality of constraints, and a convex hull;
(2) initializing a node list with a solution of the SSE objective function in its convex hull, an optimal solution of the SSE model to an empty set, and upper and lower bounds of the objective value of the objective function;
(3) selecting a node from the node list and initializing a first cutting plane to a constraint associated with said node;
(4) solving the objective function subject for the first cutting plane to obtain a current solution and saving the objective value of the current solution of the objective function;
(5) updating the objective value upper bound to a largest optimal objective value among current nodes;
(6) if the current solution of the SSE model is a feasible solution of the SSE model, and if the objective value of the current solution is greater than the objective value lower bound, setting the objective value lower bound to the current solution objective value and the optimal solution of the SSE model to the current solution of the SSE model;
(7) if a number of cutting plane is less than a predetermined maximum and if the objective value of the current solution is greater than the objective value lower bound, generate a plurality of new cutting planes for the current node to produce a tighter feasible region of the SSE model; and
(8) if the number of cutting plane is greater than the predetermined maximum, create two new nodes and a constraint for each new mode, and add the new nodes to the node list.

7. The method of claim 6, further comprising, if the node list is empty, setting the optimal solution of the SSE model to the current solution of the SSE model, and the optimal objective value of the SSE model to the current solution objective value.

8. The method of claim 6, further comprising, if the current solution of the SSE model is infeasible, repeating steps (3) and (4).

9. The method of claim 6, further comprising, if the objective value of the current solution is less than the objective value lower bound, repeating steps (3) through (5).

10. A non-transitory program storage device readable by a computer, tangibly embodying a program of instructions executed by the computer to perform the method steps for approximating a solution of a stochastic state estimation (SSE) model of an electric grid, comprising the steps of:
(1) choosing starting anchor points in an SSE model of an electric grid;
(2) relaxing constraints of an SSE objective function to solve for a feasible solution of the SSE model;
(3) calculating updated dual variables and infeasibility reduction directions from the feasible solution;
(4) generating a linear cut for the chosen starting anchor points;
(5) choosing a step size toward the reduction directions; and
(6) updating the anchor points through branching by making the chosen step, wherein each anchor point defines a rectangle that at least partially covers a feasible solution set of the SSE model, wherein each rectangle is a convex set, and the set of rectangles covering the feasible solution set of the SSE model define an approximate solution of the SSE model of said electric grid.

11. The computer readable program storage device of claim 10, the method further comprising (7) repeating steps (2) through (6) until either a feasible solution is found or an infeasibility check is true.

12. The computer readable program storage device of claim 11, the method further comprising (8) pre-solving a few-iterations of a primal of a convexified SSE model.

13. The computer readable program storage device of claim 12, the method further comprising (9) calculating updated primal variables and reduced cost directions.

14. The computer readable program storage device of claim 13, the method further comprising (10) repeating steps (4) through (9) until either an optimal solution is found or an iteration limit is reached.

15. A non-transitory program storage device readable by a computer, tangibly embodying a program of instructions executed by the computer to perform the method steps for finding an optimal solution of a stochastic state estimation (SSE) model of an electric grid, comprising the steps of:
(1) providing a convexified SSE model of an electric grid, said convexified SSE model including an objective function having an objective value, a plurality of constraints, and a convex hull;
(2) initializing a node list with a solution of the SSE objective function in its convex hull, an optimal solution of the SSE model to an empty set, and upper and lower bounds of the objective value of the objective function;
(3) selecting a node from the node list and initializing a first cutting plane to a constraint associated with said node;
(4) solving the objective function subject for the first cutting plane to obtain a current solution and saving the objective value of the current solution of the objective function;
(5) updating the objective value upper bound to a largest optimal objective value among current nodes;
(6) if the current solution of the SSE model is a feasible solution of the SSE model, and if the objective value of the current solution is greater than the objective value lower bound, setting the objective value lower bound to the current solution objective value and the optimal solution of the SSE model to the current solution of the SSE model;
(7) if a number of cutting plane is less than a predetermined maximum and if the objective value of the current solution is greater than the objective value lower bound, generate a plurality of new cutting planes for the current node to produce a tighter feasible region of the SSE model; and
(8) if the number of cutting plane is greater than the predetermined maximum, create two new nodes and a constraint for each new mode, and add the new nodes to the node list.

16. The computer readable program storage device of claim 15, the method further comprising, if the node list is empty, setting the optimal solution of the SSE model to the current solution of the SSE model, and the optimal objective value of the SSE model to the current solution objective value.

17. The computer readable program storage device of claim 15, the method further comprising, if the current solution of the SSE model is infeasible, repeating steps (3) and (4).

18. The computer readable program storage device of claim 15, the method further comprising, if the objective value of the current solution is less than the objective value lower bound, repeating steps (3) through (5).
